(19) United States
(12) Patent Application Publication
(10) Pub. No.: US 2008/0317962 A1
(43) Pub. Date: Dec. 25, 2008

(54) Multi-layer and composite corrosion resistant coatings

(76) Inventors: Scott Hayes, Zion, IL (US); Patrick J. Kinlen, Fenton, MO (US); James Rawlins, Petal, MS (US); Michael D. Blanton, Petal, MS (US); Yevgenia Ulyanova, Springfield, MO (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 12/074,616

(22) Filed: Mar. 5, 2008

Related U.S. Application Data
(60) Provisional application No. 60/904,965, filed on Mar. 5, 2007.

(51) Int. Cl. B05D 1/36; C09D 5/08; C09D 139/00; C09D 181/00

(52) U.S. Cl. 427/409; 525/535; 525/55; 525/540

(57) ABSTRACT

Corrosion resisting coatings for metals and methods for using them to protect metal surfaces that are subject to corrosion are described where the coatings comprise a first domain comprising a binder polymer and a second domain comprising a corrosion-responsive agent, where the first domain directly contacts the second domain.

### CROSS REFERENCE TO RELATED PATENTS AND PATENT APPLICATIONS

The present application is a non-provisional of U.S. Provisional Patent Application No. 60/904,965, filed Mar. 5, 2007.

The subject matter of the present invention is related to copending and commonly assigned U.S. patent application Ser. No. 10/454,347, filed Jun. 4, 2003, and to the U.S. Nonprovisional having attorney docket number 19506/09104, filed on the same date as the present application as a non-provisional of U.S. Provisional Patent Application No. 60/904,925, filed Mar. 5, 2007.

This invention was made with Government support under Contract Award N00421-05-C-0042 awarded by Naval Air Systems Command (NAVAIR). The Government has certain rights in the invention.

### BACKGROUND OF THE INVENTION

(1) Field of the Invention

The present invention relates to corrosion resistant coatings for surfaces of metals that are subject to corrosion, and more particularly to corrosion resistant coatings that use reduced amounts of chromate or are free of chromate.

(2) Description of the Related Art

The protection of aluminum and aluminum alloys from corrosion is of wide interest, but in aircraft applications, it becomes critical. Aluminum alloys such as 2024 and 7075 are typical of the type used for aircraft service and these alloys characteristically contain copper. Although the presence of copper provides advantageous strength and other physical properties to the alloy, it nevertheless catalyzes the oxygen reduction reaction (ORR), which is a key element in corrosion processes.

The conventional method for protecting aircraft aluminum from corrosion involves the application of a conversion coating to the bare aluminum followed by applications of a primer and a topcoat. The topcoat provides the final color and surface texture and serves as a sealant for the undercoating. However, the conversion coating and the primer provide the majority of the corrosion resistance for the metal.

Chrome conversion coatings that contain hexavalent chromium are the present standard for use as conversion coatings for aluminum. Conventional hexavalent chrome conversion coatings meet Military Specification Mil-C-5541.

The present standard primer is a chromated epoxy primer meeting Military Specifications Mil-PRF-23377. Examples of this type of primer include Deft 02-Y-40A and Hentzen 16708TEP/16709CEH.

Typical topcoats for aircraft use meet Military Specification Mil-PRF-85285. Examples include Deft 03-GY-321 and Deft 99-GY-

### SUMMARY OF THE INVENTION

Briefly, therefore the present invention is directed to a novel corrosion resisting coating for a surface of a metal that is subject to corrosion, the coating comprising: a binder polymer which is predominantly located in a first domain; and a corrosion-responsive agent which is predominantly located in a second domain which directly contacts the first domain. The corrosion-responsive agent can be selected from the group consisting of: a) a mercapto-substituted organic and dimers, trimers, oligomers, or polymers thereof, b) a thio-substituted organic and dimers, trimers, oligomers, or polymers thereof, c) a dimer, trimer, oligomer, or polymer of an organic phosphonic acid or salt or ester thereof, d) combinations of any of a), b), or c); e) a salt of a mercapto-substituted organic and an intrinsically conductive polymer, f) a salt of a thio-substituted organic and an intrinsically conductive polymer, and g) combinations of any of a)-f).

The present invention is also directed to a novel method of protecting a surface of a metal from corrosion, the method comprising: applying a to the metal surface a liquid formulation which cures to form a first domain comprising a binder polymer; and applying a liquid formulation that cures to form a second domain comprising a corrosion-responsive agent. The corrosion-responsive agent can be selected from the group consisting of: a) a mercapto-substituted organic and dimers, trimers, oligomers, or polymers thereof, b) a thio-substituted organic and dimers, trimers, oligomers, or polymers thereof, c) a dimer, trimer, oligomer, or polymer of an organic phosphonic acid or salt or ester thereof, d) combinations of any of a), b), or c); e) a salt of a mercapto-substituted organic and an intrinsically conductive polymer, f) a salt of a thio-substituted organic and an intrinsically conductive polymer, and g) combinations of any of a)-f). The application of the liquid formulation which cures to form a first domain comprising a binder polymer and the application of the liquid formulation that cures to form a second domain is optionally sequential or concurrent.

### BRIEF DESCRIPTION OF THE DRAWINGS

FIG. 1 illustrates two embodiments of the present coating, in FIG. 1(A), a metal surface is coated with a first domain layer having a second domain layer covering the first domain layer, in FIG. 1(B) multiple regions of first domain and second domain form a single layer;

FIG. 2 illustrates coating schemes for several embodiments of multi-layered coatings of the present invention;

FIG. 3 shows salt spray results (120 hours) and coating schemes for two of the BAM-PPV coatings of an embodiment of the present invention;

FIG. 4 illustrates the coating scheme for one of the two top performing layered coatings of the present invention;

FIG. 5 illustrates a layered coating containing neutralized Zn(DMcT)₂;

FIG. 6 illustrates a layered coating scheme containing PolyDMcT;

FIG. 7 shows a dual spray gun set-up for spraying multiple, discreet layers, where the guns are aimed parallel and separator is installed;

FIG. 8 shows a dual spray gun set-up for applying mixed sprays of primer and inhibitor, where the separator is removed and the guns are aimed inward to give spray patterns that overlap at or before the surface of the metal target;

FIG. 9 shows a layered coating system having good wet tape adhesion;

FIG. 10 shows a comparison showing darkening of scribe line after salt spray exposure for coupons having a primer that contains modified Zn(DMcT)₂ inhibitor which is applied over BAM-PPV pretreated 2024-T3 aluminum alloy;

FIGS. 11(a), 11(b), and 11(c) are optical micrographs of scribe lines after 1500 hours of salt spray exposure in which no pitting seen and in which the color that is seen in scribe lines (see FIG. 10) may be related to a coating forming on the metal;

FIG. 12 shows an IR spectra of sample #1 of polyDMcT;

FIG. 13 shows an IR spectra of sample #2 of polyDMcT that is different than the sample used for the spectra of FIG. 12;

FIG. 14 shows an experimental set-up for RDE experiment, schematic showing the electrochemical cell used to evaluate the release of inhibitors from a coating; and

FIG. 15 shows a representative plot of current vs. time for RDE experiment for chromate conversion coated aluminum and contacted with DMcT.

### DETAILED DESCRIPTION OF PREFERRED EMBODIMENTS

In accordance with the present invention, it has been discovered that metals that are subject to corrosion can be protected against corrosion by applying a coating that includes a corrosion-responsive agent and a binder polymer, but maintains these two components in substantially separate domains. This coating has demonstrated significantly improved corrosion protection compared with a coating having the same components in a well mixed formulation. Yet, the novel coating retains good qualities of adhesion and toughness.

When the agent that provides the corrosion-protective activity of the coating is a corrosion-responsive agent, as will be discussed below, the coating can be made to be either totally or substantially free of chromium (VI) and nevertheless provides excellent corrosion-protective qualities.

In one embodiment, the novel coating is applied to a metal surface having a chromium conversion coat. As will be understood by those having skill in the art of corrosion protective coatings, a conventional chromium corrosion protection system includes a chromium conversion coat (CCC), which is applied directly onto the metal surface, and a chromium-containing primer, which is applied over the CCC. Although both coatings contain Cr(VI), a toxic form of chromium, It is usual for the CCC to contain only a small fraction of the total chromium of the coating system (often only about 5%), while the primer contains the major portion of the chromium (often almost 95%). Accordingly, the replacement of a Cr(VI)-containing primer with the chromium-free primer of the present invention reduces the chromium content of a coating system very significantly, even when the novel coating is applied over a CCC.

However, it has also been found that the novel coating can be applied over a chromium-free conversion coat, such as a conversion coating of poly [bis(2,5-(N,N,N′,N′-tetralkyl)amine)-1,4-phenylene vinylene] (BAMPPV) as described by Anderson, N. and P. Zarras in Currents, 60-62, Spring 2005. This embodiment provides a chromium-free coating system that provides excellent corrosion protection.

The inventors have found that when the novel coating comprising a corrosion-responsive agent is applied over a CCC, it is preferred that the domain that contains the corrosion-responsive agent is isolated from contact with the CCC, preferably by the domain that contains the binder polymer. Surprisingly, the inventors have found that the isolation of the corrosion-responsive agent from contact with chromium (VI) prevents or minimizes the reduction of the chromium (VI) to chromium (III) and the oxidation of the corrosion-responsive agent, thereby reducing or preventing chemical interaction between the two components and maintaining the corrosion-protective qualities of each.

The present coating can be advantageously applied to the surface of any metal that is subject to oxidative corrosion in order to prevent or reduce corrosion. In particular, the coating is useful for the protection of iron, steel and aluminum, and especially for aluminum alloys that contain copper. Some embodiments of the novel coating have shown that the application of the present coating to aluminum alloys such as 2024 and 7075 provided protection against corrosion in salt-spray environments that was equal to or better than the protection provided by conventional chromium coatings.

The present coating comprises a first domain that contains a binder polymer and a second domain which contains a corrosion-responsive agent. It is preferred that a first domain directly contacts a second domain. As used herein, the term “domain” means a chemically distinct portion or region of a solid coating. By way of example, in the present coating the first domain and the second domain can be layers that are applied one over the other on the surface of the metal to form a multi-layered coating. A layer of a first domain contacts a layer of a second domain and more layers can follow in alternating sequence if desirable. Moreover, there can be multiple layered coatings in which a layer of a binder polymer can be followed by several layers of a corrosion-responsive agent, and those then topped with a layer of binder polymer.

As another example, the first domain and the second domain can be applied as adjacent or overlapping dots or droplets to form a single composite layer, such as is obtained from droplets of two different sprays having patterns that overlap at or before contact with the surface of the metal. One spray of material to form a first domain can overlap with a spray of a material to form a second domain with the result of a single layer composite coating on the target surface.

The present coating can be applied in any thickness that provides the desires qualities of corrosion-protection, flexibility, adhesion and durability. In some embodiments the thickness of the coating is from about 0.001 mm to about 0.2 mm, or from about 0.01 mm to about 0.1 mm, or from about 0.015 mm to about 0.025 mm.

In the first domain of the present coating, the binder polymer predominates and is present in an amount of at least about 50% by weight. In some embodiments, the first domain can include the binder polymer in an amount of at least about 60%, or 70%, or 75%, or 80%, or 85%, or 90%, or 95%, or even substantially 100%, all based on the weight of the first domain.

The binder polymer of the present coating can be any polymer, copolymer, or a mixture of different polymers. The polymer can be a thermoplastic or a thermoset. Polymers that are useful as binder polymers in the present invention include phenolic resins, alkyd resins, aminoplast resins, vinyl alkyds, epoxy alkyds, silicone alkyds, uralkyds, epoxy resins, coal tar epoxies, urethane resins, polyurethanes, unsaturated polyester resins, silicones, vinyl acetates, vinyl acrylics, acrylic resins, phenolics, epoxy phenolics, vinyl resins, polyimides, unsaturated olefin resins, fluorinated olefin resins, cross-linkable styrenic resins, crosslinkable polyamide resins, rubber precursor, elastomer precursor, ionomers, mixtures and derivatives thereof, and mixtures thereof with crosslinking agents.

In a preferred embodiment of the present invention, the binder polymer is a cross-linkable polymer (a thermoset), such as the epoxy resins, polyurethanes, unsaturated polyesters, silicones, phenolic and epoxy phenolic resins. Exemplary cross-linkable resins include aliphatic amine-cured epoxies, polyamide epoxy, polyamine adducts with epoxy, kerimine epoxy coatings, aromatic amine-cured epoxies, silicone modified epoxy resins, epoxy phenolic coatings, epoxy urethane coatings, coal tar epoxies, oil-modified polyurethanes, moisture cured polyurethanes, blocked urethanes, two component polyurethanes, aliphatic isocyanate curing polyurethanes, polyvinyl acetals and the like, ionomers, fluorinated olefin resins, mixtures of such resins, aqueous basic or acidic dispersions of such resins, or aqueous emulsions of such resins, and the like. Methods for preparing these polymers are known or the polymeric material is available commercially. It should be understood that various modifications to the polymers can be made such as providing it in the form of a copolymer. The binder polymer can be aqueous based or solvent based and can be radiation-cured, cured by heat, by removal of a solvent, or by the action of a catalyst or promoter.

The binder polymer can be, or can include an intrinsically conductive polymer (ICP). As used herein, “intrinsically conducting polymer” means any polymer that is capable of conducting an electrical current in at least one valence state of the polymer. Generally, intrinsically conducting polymers are organic polymers that have poly-conjugated ττ-electron systems. Examples of suitable intrinsically conducting polymers for use in connection with the present invention include polyaniline, polypyrrole, polythiophene, poly(3-alkyl-thiophenes) such as poly(3-hexyl thiophene), poly(3-methyl thiophene) and poly-(3-octyl thiophene), polyisothianapthene, poly-(3-thienylmethylacetate), polydiacetylene, polyacetylene, polyquinoline, polyheteroarylenvinylene, in which the heteroarylene group can be thiophene, furan or pyrrole, poly-(3-thienylethylacetate), and the like, and derivatives, copolymers and mixtures thereof. Some intrinsically conducting polymers exhibit the electrically conductive property naturally while others must be doped or charged to the proper valence state. ICPs typically exist in various valence states and are reversibly convertible into the various states by electrochemical reactions. For example, polyaniline can exist in numerous valence states such as a reduced state (leucoemeraldine), a partially oxidized state (emeraldine) and a fully oxidized state (pernigraniline). Polyaniline is most conductive in its emeraldine form (+2 electrons). This partially oxidized state of polyaniline can be formed by doping polyaniline with a suitable dopant to increase the electrical conductivity of the polymer. Examples of suitable dopants include tetracyanoethylene (TCNE), zinc nitrate, p-toluenesulfonic acid (PTSA), mercapto-substituted organic compound such as 2,5-dimercapto-1,3,4-thiadiazole, or any suitable mineral or organic acid. In a preferred embodiment, the ICP is polyaniline.

In addition to the binder polymer, the first domain can contain other materials. Any plasticizer, colorant, curing catalyst, residual monomer, surfactant, or any other material that adds useful properties to the first domain, or at least does not reduce the functionality of the first domain can be included in the first domain in amounts that are known to those of skill in the art of polymer compounding.

The first domain can also contain a small amount of the corrosion-responsive agent. It is preferred however, that the first domain contain no more than about 10% by weight of the corrosion-responsive agent, and no more than 5%, or 3%, or 1%, by weight, is preferred. The first domain can be substantially free of the corrosion-responsive agent.

In the present invention the first domain can be formed in any manner. In one useful method, the first domain is formed by applying to the material to be protected a liquid formulation that cures to form the first domain. The liquid formulation can be solvent-free or it can contain a solvent. The formulation can be aqueous-based, organic-based, or a mixture of the two. Typically it contains the components of the first domain with or without a solvent in a liquid solution, emulsion, micro-emulsion, dispersion, or mixture. After the liquid formulation is applied to the surface, or to a coating that has previously been applied to the surface, it can be cured to form a solid that is a first domain. As will be discussed in detail below, it is common for the liquid formulation to be applied as a layer, or in the form of small droplets as a spray.

The second domain of the coating comprises at least one corrosion-responsive agent. A second domain can contain the corrosion-responsive agent in an amount of at least about 10% by weight, and 20%, or 30%, or 50%, or 75%, or even substantially 100%, by weight, is preferred. The second domain can contain the corrosion-responsive agent in an amount that is at least equal to the critical pigment volume concentration (CPVC), or even higher.

In some embodiments of the present second domain, the corrosion-responsive agent is provided in the form of fine particles that are intermixed in a resin that cures to form the binder polymer or a different polymer. As used herein, the terms, “critical pigment volume concentration”, or “CPVC”, refer to the point at which there is just sufficient polymer to wet the pigment particles. Below the CPVC there is sufficient polymer for wetting all of the particles of the corrosion-responsive agent and above the CPVC there is not. There can be abrupt changes in the coating properties at the CPVC.

As used herein, the terms “corrosion-responsive agent” (“CRA”), refer to a compound that releases a corrosion-inhibiting anion in response to electrochemical (oxidation/reduction) conditions characteristic of those present on a metal surface undergoing oxidative corrosion. As is well known to those skilled in the study of metal corrosion, oxidative corrosion of a metal by contact with oxygen and water causes the formation of an electrogalvanic cell that is characterized by the presence of metal cations, hydroxyl anions, and the like. When the corrosion-responsive agent of the present invention is in operative contact with such a corroding metal surface, it is believed to react with one or more of the ions that are a part of the oxidative corrosion electrogalvanic cell to produce a corrosion-inhibiting anion. Therefore, the corrosion-responsive agent itself undergoes oxidation or reduction in response to its exposure to the corrosion. However, under non-corrosive conditions, the corrosion-responsive agent remains unreacted and stable, and has a low rate of spontaneous ionization to release a corrosion-inhibiting anion.

The corrosion-inhibiting anion can be an inorganic anion or an organic anion. Examples of inorganic ions that can act as the corrosion-inhibiting ion of the present invention include an anion that is selected from the group consisting of: CrO₄²⁻, CrO₁₂H₈⁵⁻, PO₄³⁻, HPO₄³⁻, MoO₄²⁻, BO₂²⁻, SiO₃²⁻, NCN²⁻, HPO₃²⁻, NO²⁻, P₃O₁₀⁵⁻; and CO₃²⁻. In preferred embodiments, the inorganic corrosion-inhibiting anion can be selected from the group consisting of: PO₄³⁻, HPO₄³⁻, MoO₄²⁻, BO₂²⁻, SiO₃²⁻, NCN²⁻, and P₃^{O}₁₀⁵⁻.

The corrosion-inhibiting anion of the present invention can be an organic anion. The organic corrosion-inhibiting anion can be formed by the ionization of a corrosion-responsive agent that is selected from the group consisting of mercapto-substituted organics, thio-substituted organics, and dimers, trimers, oligomers, and polymers thereof. Examples of useful mercapto-substituted organic corrosion-responsive agents include a mercapto-substituted aryl or heteroaryl. Particularly useful mercapto-substituted organic corrosion-inhibiting agents include 2,5-dimercapto-1,3,4-thiadiazole (DMcT) and poly(DMcT).

Examples of compounds that are useful as CRA's in the present invention include 1-(4-hydroxyphenyl)-1H-tetrazol-5-thiol, 1,2,4-triazole-3-thiol, 1-pyrollidinecarbodithioic acid, 2,2′-dithiobis(benzothiazole), 2,4-dimercapto-6-amino-5-triazine, 2,4-dithiohydantoin, 2,5-dimercapto-1,3,4-thiodiazole, 2,5-dimethylbenzothiazole, 2-amino-1,3,4-thiadiazole, 2-mercapto-5-methylbenzimidazole, 2-mercapto-5-nitrobenzimidazole, 2-mercaptobenzimidizole, 2-mercaptobenzoxazole, 2-mercaptoethane sulfonic acid, 2-mercaptoimidazole, 2-mercaptothiazoline, 2-thiouracil, 3-amino-5-mercapto-1,2,4-triazole, 5,5-dithio-bis(1,3,4-thiadiazole-2(3H)—-thione, 5-amino-1,3,4-thiadiazole, 6-amino-2-mercaptobenzothiazole, 6-ethoxy-2-mercaptobenzothiazole, 6-mercaptopurine, -alky- or N-cycloalkyl-dithiocarbamates, alkyl- and cyclo-alkyl mercaptanes, benzothiazole, dimercapto pyridine, dimethyldithio carbamic acid, dithiocyanuric acid, mercaptobenzothiazole, mercaptobenzoxazole, mercaptoethanesulfonic acid, mercaptoimidazole, mercaptopyridine, mercaptopyrimidine, mercaptoquinoline, mercaptothiazole, mercaptothiazoline, mercaptotriazole, O,O-dialkyl- and O,O-dicycloalkyl-dithiophosphates, O-alkyl- or O-cycloalkyl-dithiocarbonates, o-ethylxanthic acid, quinoxaline-2,3-thiol, thioacetic acid, thiocresol, thiosalicylic acid, trithiocyanuric acid, and dimers, trimers, oligomers, and polymers thereof.

The corrosion-inhibiting agent optionally can be an organic phosphonic acid or a dimer, trimer, oligomer, polymer, salt or ester thereof. Organic phosphonic acids can be mono-, di-, tri-, tetra-, or polyphosphonic acids. Phosphonic acids that are di-, tri-, tetra-, or poly-phosphonic acids (which may be termed “polyphosphonic acids herein) are preferred for use in the present invention. Other acidic groups, such as carboxylic, boric, and the like, can also be present on the molecule in addition to the phosphonic acid groups. Polymers that have at least two pendent phosphonic acid groups, wherein each such pendent phosphonic acid group is a mono-functional phosphonic acid group, are also included as polyphosphonic acids.

A preferred form of phosphonic acids are aminoalkylphosphonic acids and hydroxyalkylphosphonic acids having the general formula:

R¹—(CH₂—(PO₃)M₂)ₓ, or

R¹—((PO₃)M₂)ₓ

where:

M is selected from the group consisting of hydrogen, an alkaline metal, alkyl, alkenyl, alkynyl, alkoxy, aryl, cyclic, heteroaryl, and heterocyclic;

R¹ is selected from the group consisting of amino, aminoalkyl, and hydroxyalkyl; and

x is a number equal to the valence of R¹, provided that x is 1 or higher.

In another embodiment, x is 2 or higher.

Illustrative of some of the organic phosphonic acids that are useful in the present invention are: n-octyldecylaminobismethylenephospho-nic acid, dodecyldiphosphonic acid, ethylidenediaminotetramethylenephospho-nic acid, hydroxyethylidenediphosphonic acid, 1-hydroxyethylidenel1,1-dipho-sphonic acid, isopropenyldiphosphonic acid, N,N-dipro pynoxymethylaminotrimethylphosphonic acid, oxyethylidenediphosphonic acid, 2-carboxyethylphosphonic acid, N,N-bis(ethynoxymethyl)aminomethyltriphosphonic acid, nitriletrimethylenephosphonic acid, aminotrimethylenephosphonic acid, diethylenetriaminepentakis(methylenephosphonic) acid, amino(trimethylenephosphonic acid), nitrilotris(methylenephosphonic acid), ethylenediaminotetra(methylenephosphonic acid), hexamethylenediaminetetra(methylenephosphonic acid), diethylenetriaminepenta(methylenephosphonic acid), glycine,N,N-bis(methyle-nephosphonic acid), bis(hexamethylenetriaminepenta(methylenephosphonic acid), and 2-ethylhexyiphosphonic acid.

Suitable organic phosphonates that are useful in the present invention also include alkali metal ethane 1-hydroxy diphosphonates (HEDP), alkylene poly(alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphoniate compounds may be present either in their acid form or as salts of different cations on some or all of their acid functionalities. Preferred phosphonates include diethylene triamine penta methylene phosphonate (DTPMP) and ethane 1′-hydroxy, diphosphonate (HEDP). Such phosphonates are commercially available from Monsanto under the trade name DEQUEST®.

Optionally, the corrosion-responsive agent is the salt of an intrinsically conductive polymer and the corrosion-inhibiting anion of a CRA that is selected from any of the corrosion-inhibiting agents described above. The CRA can be a salt of a mercapto-substituted organic and an intrinsically conductive polymer, or a salt of a thio-substituted organic and an intrinsically conductive polymer. A preferred salt of an ICP and a corrosion-responsive agent is the 2,5-dimercapto-1,3,4-thiadiazole salt of polyaniline (PANiDMcT).

The corrosion-responsive agent can also be provided by a neutralized metal salt of a corrosion-responsive agent.

The neutralized metal salt of a CRA can comprise a cation that is a metal and an anion of one of the CRA's that is described herein. Typically, the corrosion-inhibiting anion of the present invention can be an organic anion such as one that is formed by the ionization of a corrosion-responsive agent that is selected from the group consisting of mercapto-substituted organics, thio-substituted organics, and dimers, trimers, oligomers, and polymers thereof. Examples of useful mercapto-substituted organic corrosion-responsive agents include a mercapto-substituted aryl or heteroaryl. A particularly useful mercapto-substituted organic corrosion-inhibiting agent is 2,5-dimercapto-1,3,4-thiadiazole.

In one embodiment, it was found that a neutralized Zn(DMcT)₂ salt is an effective corrosion-responsive agent that is free of chromate. As used herein with respect to metal salts of corrosion inhibiting organic anions, such as Zn(DMcT)₂, the term “neutralized” means that the metal salt has been contacted with one or more neutralizing compounds that raise the pH of the salt/neutralizing compound combination to within a range of from about 5 to about 9, a range of from about 5.5 to about 8.5 is preferred, a range of from about 6 to about 8 is more preferred, a range of from about 6.5 to about 7.5 is yet more preferred, a range of from about 6.8 to about 7.2 is even more preferred, and a pH of about 7 is yet more preferred. When the pH of the metal salt of the organic anion is described, what is meant is the pH measured in a 10% by weight aqueous solution or dispersion of the metal salt and the neutralizing compound(s) at room temperature.

The metal salt of a corrosion-responsive agent of the present invention is a metal salt of a corrosion-inhibiting monovalent, divalent, or polyvalent organic anion as described above. The metal that acts as the cation of the salt is preferably selected from Zn(II), Al(III), Nd(III), Mg(II), Ca(II), Sr(II), Ti(IV), Zr(IV), Ce(III or IV), and Fe(II or III). Preferred metals include Zn, Nd and Sr.

It has been found that the Zn(II), AI(III), Nd(III), Mg(II), Ca(II), Sr(II), Ti(IV), Zr(IV), Ce(III or IV), and Fe(II or III) metal salt of a CRA can be neutralized by contacting it with a Group IA metal salt of the same or a different CRA. As an example, Zn(DMcT)₂ can be contacted with, for example, K₂(DMcT) to form a mixture of the zinc salt and the potassium salt of the CRA having a pH within the desired range.

The CRA of the present coating can be any combination of any of the CRA compounds that are discussed herein.

In the present invention the second domain can be formed in any manner. It is useful, however, to form the second domain by applying to the metal to be protected, or to a coating covering the metal, a liquid formulation that cures to form the second domain. The liquid formulation can be solvent-free or it can contain a solvent. The formulation can be aqueous-based, organic-based, or a mixture of the two. Typically it contains the components of the second domain with or without a solvent in a liquid solution, emulsion, micro-emulsion, dispersion, or mixture. After the liquid formulation is applied to the surface, or to a layer of material that has previously been applied to the surface, it can be cured to form a solid that is a second domain. As will be discussed in detail below, it is common for the liquid formulation that cures to form the second domain to be applied as a layer under and/or over a layer of the first domain, or in the form of small droplets as a spray that is intermixed with small droplets of a liquid formulation that cure to form the first domain.

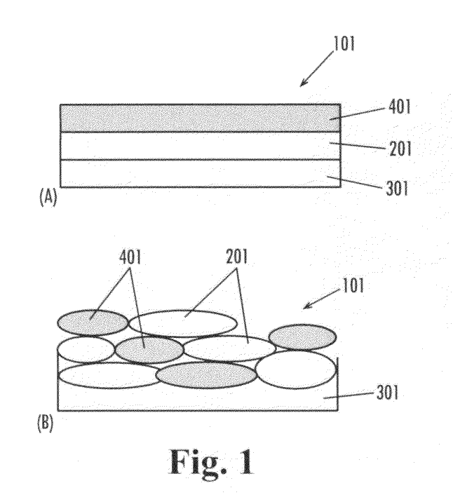

Two embodiments of the present coating are shown in FIG. 1. In FIG. 1(A) the first domain and the second domain are adjacent layers and the coating (101) is illustrated as a layer of the first domain (201) adjacent to and covering the surface of the metal (301), and wherein the first domain layer is covered with a layer of the second domain (401). The coating can further comprise one or more additional sequences of the first domain layer and the second domain layer and can have a topmost layer of the first domain. Optionally, there can be multiple layers of a first domain or a second domain in sequence.

In FIG. 1(B), the first domain and the second domain together form a single layer comprising multiple discrete but touching or overlapping regions of each of the first domain and the second domain and the coating (101) is illustrated as a single layer composed of touching first domain (201) and second domain (401) regions, as might be formed by overlapping spray patterns from two different nozzles—one spraying a liquid formulation that cures to form a first domain, the other spraying a liquid formulation that cures to form a second domain.

As mentioned above, the present coating can be applied directly to a metal surface or it can be applied over a pre-coat or conversion coating. In one embodiment, the novel coating is applied over a chrome conversion coating (CCC), in another embodiment, the coating is applied over a coating of poly [bis(2,5-(N,N,N′,N′-tetralkyl)amine)-1,4-phenylene vinylene] (BAMPPV), which is located between the metal surface and the corrosion resisting coating.

When a chrome conversion coating is used, the novel coating can be separated from the CCC by a barrier layer. The barrier layer can be any polymer. Examples of polymers that are useful as the barrier layer are those that are described in the section on binder polymers.

The present invention includes a method of protecting a surface of a metal from corrosion. The novel method typically comprises applying to the metal surface a liquid formulation which cures to form a first domain comprising a binder polymer and applying a liquid formulation that cures to form a second domain. The second domain comprises a corrosion-responsive agent that is selected from the group consisting of: a mercapto-substituted organic and dimers, trimers, oligomers, or polymers thereof, a thio-substituted organic and dimers, trimers, oligomers, or polymers thereof, a dimer, trimer, oligomer, or polymer of an organic phosphonic acid or salt or ester thereof, combinations of any of these three, a salt of a mercapto-substituted organic and an intrinsically conductive polymer, a salt of a thio-substituted organic and an intrinsically conductive polymer, a neutralized metal salt of a mercapto-substituted organic; and combinations of any of these. The application of the liquid formulation which cures to form a first domain and the application of the liquid formulation that cures to form a second domain is optionally sequential or concurrent.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### Example 1

This illustrates the synthesis of polyaniline doped with 2,5-dimercapto-1,3,4-thiadiazole (PANiDMcT).

PANiDMcT is made by first mixing approximately equimolar amounts of aniline and DMcT together in water. This mixture is then placed in a chilled (2° C.) reactor vessel. An aqueous solution of the oxidant, ammonium peroxydisulfate, is slowly added to the reactor. When the reaction is complete, the product is filtered, washed, and dried.

Oxidation of aniline will produce polyaniline which is doped by the DMcT present in the polymerization solution to give PANiDMcT. Oxidation of the thiol groups of DMcT will form disulfide bonds, thus leading to dimers, oligomers or polymers of DMcT. Analytical data indicates that oxidation products of DMcT are formed in addition to PANiDMcT.

An example of the synthesis of DMcT-Salt of Polyaniline (Blender Method) is as follows:

2,5-dimercapto-1,3,4-thiadiazole (93 grams) was ground in a mortar with a pestle to a fine powder. The powder was added to deionized water in a Waring blender and emulsified in the blender for 1 minute. Aniline (57 grams) was added to the mixture in the blender and emulsified for 1 minute. The mixture in the blender was transferred to a 3 liter round-bottom jacketed flask that was cooled to about 5° C. and blanketed with nitrogen. Ammonium peroxodisulfate (170 grams, APDS) was dissolved in deionized water and transferred to an addition funnel, which was attached to the round-bottom flask. The APDS solution was then added dropwise to the mixture in the flask over a period of about 15 minutes while maintaining the temperature of the mixture in the flask below about 5° C. The mixture was stirred for 3 hours at about 5° C. under a nitrogen blanket. The product was recovered by filtration, and the solid product was washed with deionized water.

An example of the synthesis of DMcT-Salt of Polyaniline by the Eiger Mill Method is as follows:

The following materials were added to an Eiger mill (Model Mini 100 Motormill, Eiger Machinery, Inc., Grayslake, Il.): glass beads (60 ml), deionized water (325 ml), 2,5-dimercapto-1,3,4-thiadiazole (25 g, DMcT, CAS No. 1072-71-5). The charge was milled at 5000 rpm for about 15 minutes to produce a fine yellow slurry. Then aniline (15.32 g) was added dropwise over about 18 to 40 minutes, while the mill was operated at a speed of 5000 rpm. The mixture in the mill was milled an additional time period (up to 45 minutes) and then discharged from the mill.

The above procedure was repeated twice more and the three products of the procedure were combined and added to a 3 liter jacketed round-bottomed flask with an overhead stirrer. To the salt mixture was added dropwise 138 g ammonium peroxidisulfate (APS) in water at 2° C. The reaction exotherm of 13° C. was noted 77 minutes after the beginning of the APS addition. The dark-green-black slurry was stirred overnight at 2° C.

The slurry of fine particles was filtered, washed three times with 1000 ml deionized water, air dried, and then dried in a vacuum oven to give the product powder. The particles size by light microscopic examination was estimated to be less than about 20 microns.

Prior to incorporation into a primer, the solid CRA is ground in a jar mill using a solvent compatible with the primer resin. The PANiDMcT CRA can be applied by:

a) the conventional method of directly mixing the CRA with the polymer prior to application. However, dedoping due to the amine curing agent of the epoxy resin can be a problem if the CRA and the binder polymer are intermixed;

b) the layered approach in which the binder polymer and the CRA are alternately applied as separate layers; or

c) the mixed spray technique in which the binder polymer and the CRA are applied simultaneously from two separate spray guns in such a way that the spray streams are mixed while the coating is applied.

Binder polymers have included solvent-borne and water-borne epoxies. Substrates have included 2024-T3 and 7075-T6 aluminum substrates.

Pretreatments have included chromate conversion coatings (CCC) and poly(2,5-bis(N-methyl-N-hexylamino)-p-phenylene vinylene (BAM-PPV) conversion coatings. Successful corrosion test results with PANiDMcT were obtained by using mixed spray application over a chromate conversion coating applied to 2024-T3.

### Example 2

This illustrates the synthesis of poly(2,5-dimercapto-1,3,4-thiadiazole) (polyDMcT)

PolyDMcT is made by dissolving 2,5-dimercapto-1,3,4-thiadiazole (DMcT) in dimethylformamide solvent (DMF), then mixing with another solvent, acetone, in a jacketed reactor vessel. The oxidant, hydrogen peroxide, is then slowly added to the reactor vessel, and the temperature is maintained at about 40° C. until the reaction is complete.

Hydrogen peroxide oxidizes the thiol groups of DMcT, allowing DMcT to polymerize through formation of disulfide bonds.

An example of one embodiment of the synthesis of polyDMcT is as follows:

2,5-dimercapto-1,3,4-thiadiazole (25 grams, DMcT, available from Sigma-Aldrich, Milwaukee, Wis.) was added to 50/50 deionized water/methanol (1500 ml). Sodium hydroxide (6.66 grams) was then added to the mixture with stirring until the mixture became a clear transparent yellow. The mixture was heated to about 45° C. with stirring. In a separate flask, iodine (42.13 grams) was dissolved in methanol (400 ml) transferred to an addition funnel that is attached to the round-bottom flask holding the DMcT mixture. The iodine solution was added dropwise to the DMcT mixture in the flask with stirring over a period of about 30 minutes. A precipitate formed immediately and was initially white, but became reddish brown as the iodine solution was added. After stirring for 2 hours, the product was recovered by filtration, and the product was washed with acetonitrile, methanol and deionized water. The solid product was dried at 70° C. until dry. Product was a light yellow solid.

Prior to incorporation into a resin, the CRA is ground in a jar mill using a solvent compatible with the primer resin. Application methods are the same as those described above for PANiDMcT.

### Example 3

This example shows chemical and physical characterization of DMcT, PolyDMcT and PANiDMcT synthesized by the methods described above in Examples 1-2.

In these tests, samples are identified as #1, #2, #3 . . . etc., as follows:

List of Samples for testing:

| | |
|---|---|
| #1 | DMcT, from Aldrich, new |
| #2 | DMcT, from Aldrich, |
| #3 | DMcT, from Aldrich, old, date container opened is |
| | unknown |
| #4 | DMcT, from ASV |
| #5 | DMcT dimer, Vanlube 829 |
| #6 | PolyDMcT synthesized from ASV material (monomer was same |
| | as #4) |
| #7 | PolyDMcT, made by the iodine route |
| #8 | DMcT from R.T. Vanderbilt, |
| #9 | PANiDMcT |

*#1 and #3 were from the same lots, but different shipments separated by several months.

### Elemental Analysis of Inhibitors

Elemental analysis was performed on the samples listed in Table 1.

TABLE 1
Samples submitted for elemental analysis

| CRA Compound | Sample # or Lot # | Comments |
|---|---|---|
| DMcT | ASV 1342-06263.04 | First shipment from ASV |
| PolyDMcT | 2003-13-141 | ASV monomer, peroxide |
| | | process |
| PolyDMcT | ERH0070 | Iodine process |
| PANiDMcT | 2003-11071013-133 | |

The samples were dried in a vacuum oven for four days at 35° C. Temperature was kept low to ensure that there was no decomposition. An outside laboratory performed three types of analyses: carbon, hydrogen, and nitrogen by combustion, oxygen by pyrolysis, and sulfur by combustion.

### Findings:

DMcT from different sources (#4) and (#8) showed no measurable differences by FTIR. There were two very small peaks present in the Raman spectra for the (#8) sample that were not present in the (#4) sample.

DMcT in sample (#4) and DMcT in sample (#8) showed no differences in the major HPLC chromatographic peaks. A large shoulder on the largest peak in each chromatogram may indicate the presence of an impurity.

FTIR-TGA showed the presence of oxygen containing decomposition products such as carbon dioxide, water, and sulfur dioxide in some of the samples. The samples included DMcT (#4), polyDMcT (#7), and PANiDMcT (#9). No oxygen should be present in these compounds according to their molecular formulae. The oxygen containing decomposition products may be due to impurities instead of adsorbed water or CO₂ since the products were given off at temperatures well above 100° C., or even 200° C. in some cases. The fact that this was true for DMcT, one of the synthesis materials for polyDMcT and PANiDMcT, suggests the starting material is a source for at least some of the contamination.

### Elemental Analysis of CRA's

Tables 2-5 summarize the results and give the theoretical elemental percentages for each product. More than one set of calculations was generated with different assumptions, particularly for PANiDMcT. It should be noted that the analysis method for hydrogen had a lower detection limit of about 0.5%. Also, there were three separate analyses to obtain all of the data for each sample, so the experimental masses may not sum to exactly 100%.

TABLE 2
Elemental analysis results of DMcT from ASV

| Element | Theoretical % mass | Experimental % mass |
|---|---|---|
| Carbon | 15.99 | 16.02 |
| Hydrogen | 1.34 | 1.43 |
| Nitrogen | 18.64 | 18.58 |
| Oxygen | 0.00 | 1.16 |
| Sulfur | 64.03 | 62.88 |
| Totals | 100.00 | 100.07 |

For DMcT, 1.16% oxygen was found. While this could be from water, it is interesting to note that the experimental results for carbon and nitrogen agree almost exactly with the calculated values based on the molecular formula. Both the sulfur and hydrogen show the biggest deviation from the theoretical calculations. Some question exists over the sample prep methods. One modification of the procedure in the future may be to dry the samples immediately before analysis. The drying conditions must be chosen with caution to prevent thermal degradation of the samples.

TABLE 3
Elemental analysis of polyDMcT synthesized with the iodine
process

| Element | Theoretical % mass | Experimental % mass |
|---|---|---|
| Carbon | 16.19 | 17.74 |
| Hydrogen | 0.10 | 0.50 |
| Nitrogen | 18.88 | 17.89 |
| Oxygen | 0.00 | 2.78 |
| Sulfur | 64.83 | 60.83 |
| Totals | 100.00 | 99.74 |

PolyDMcT from the iodine process showed an even higher percentage of oxygen. While the percentage of hydrogen is high, the measured value is the lower detection limit given for the analysis. Hydrogen content calculations did account for the endgroups (assuming the terminal sulfides are protonated) because polyDMcT is actually an oligomer of thirteen to fourteen repeat units based on GPC results.

TABLE 4
Elemental analysis of polyDMcT synthesized with the H₂O₂
process

| Element | Theoretical % mass | Experimental % mass |
|---|---|---|
| Carbon | 16.19 | 17.54 |
| Hydrogen | 0.10 | 0.50 |
| Nitrogen | 18.88 | 18.50 |
| Oxygen | 0.00 | 1.41 |
| Sulfur | 64.83 | 63.87 |
| Totals | 100.00 | 101.82 |

Comparing the data for oxygen, there was less oxygen in the polyDMcT synthesized by the peroxide route than the iodine route.

TABLE 5
Elemental Analysis of PANiDMcT

| | | | Theoretical | |
|---|---|---|---|---|
| | Theoretical % | Theoretical % | % mass, | |
| | mass, | mass, | Assumption | Experimental |
| Element | Assumption A | Assumption B | C | % mass |
| Carbon | 50.73 | 39.62 | 39.96 | 29.58 |
| Hydrogen | 3.34 | 2.91 | 2.09 | 2.05 |
| Nitrogen | 16.90 | 17.42 | 17.57 | 15.76 |
| Oxygen | 0 | 0 | 0 | 9.52 |
| Sulfur | 29.02 | 40.05 | 40.39 | 43.72 |
| Totals | 100.00 | 100.00 | 100.00 | 100.63 |

PANiDMcT could be simply polyaniline doped with DMcT (PANiDMcT), or it may also contain products from the oxidation of DMcT into oligomer or polymer. To take this into account, the theoretical % mass of each element was calculated under three different scenarios.

Assumption A: This calculation considers the entire product as polyaniline fully doped with DMcT. This means that there would be one DMcT molecule for every two aniline repeat units in the polyaniline chain. The stoichiometric ratio of aniline to DMcT to make this product is 2:1. The synthesis contains an excess of DMcT as the molar ratio of aniline to DMcT is 1:1. For this calculation, all of the excess DMcT is treated as if it were soluble and rinsed away during the washing steps, leaving behind only PANiDMcT.
Assumption B: This calculation treats the ratio of aniline and DMcT in the final product as equal to the 1:1 ratio in the synthesis. Calculation of hydrogen is problematic since the amount depends on the form of DMcT present. Formation of disulfide bonds by oxidation eliminates hydrogen as does deprotonation related to the pH and the acid/base equilibria for DMcT. This calculation treats all aniline as being present in the polymeric form and having lost two hydrogens in polymerizing; polyaniline as being fully protonated; and all DMcT as having both hydrogens present.
Assumption C: This calculation treats the ratio of aniline and DMcT in the final product as equal to the 1:1 ratio in the synthesis. This calculation differs from B by treating all DMcT as completely deprotonated (doubly ionized), thus producing a lower estimate of the hydrogen content than Assumption B.

The most obvious difference between the calculated percentages and the experimental results is the 9.52% oxygen content. One possibility is that this could be from water, but there may be another explanation. Table 6 displays the mass ratio of nitrogen to sulfur for the calculated and experimental contents.

TABLE 6
Ratio of nitrogen to sulfur in PANiDMcT

| | | | Calculated | |
|---|---|---|---|---|
| | Calculatad | Calculated | Ratio by | |
| | Ratio by | Ratio by | Assumption | Experimental |
| Element | Assumption A | Assumption B | C | Ratio |
| Nitrogen | 1 | 1 | 1 | 1 |
| Sulfur | 1.72 | 2.30 | 2.30 | 2.77 |

The ratio of nitrogen to sulfur, which is independent of water content, is significantly higher for the experimental results than for the theoretical calculations. There is one possibility that could at least partly explain both the high sulfur content and the oxygen content, and that is the presence of sulfate. Ammonium peroxydisulfate is used as the oxidant in the PANiDMcT synthesis, and it would convert during the reaction to sulfate, which in turn could act as a dopant for polyaniline. This isn't, however, the only explanation for the high sulfur to nitrogen ratio.

Considering that the theoretical ratio of nitrogen to sulfur in polyDMcT is 1:3.43 as can be calculated from Tables 3 or 4 above. Another explanation for the high sulfur content, then, is that more aniline is lost during the reaction than DMcT. In other words, the percent yield of polyaniline from the reaction is lower than the percent of DMcT and DMcT products (includes dopant and oxidation products of DMcT) recovered in the end.

### pH of CRA Slurries

Given the problems with reactivity of the CRA's with the resin, simple tests were conducted to gauge the acidity of the non-chrome CRA's.

10% (wt/wt) slurries mixed in glass vials with filtered, Dl-H₂O (18.2MΩ). After mixing, slurries were allowed to sit overnight, except for cysteine and 2-mercapto-4-methyl-5-thiazol acetic acid which were made four hours before measurements were taken. Most samples had settled, so the measurement was taken in the liquid above. The PANi base, however, had remained suspended.

Polyaniline doped with dinonylnaphthalenesulfonic acid (PANi-DNNSA) was filtered so that the organic domain would not coat the electrode.

None of the CRA's were completely solubilized when measurements were taken, except for the dipotassium salt of DMcT. pH measurements were made with an Accumet AR 15 pH meter. The results of mixing the non-chrome CRA's into water are shown in Table 7. Most of the materials tested were quite acidic with the exception of the dipotassium salt of DMcT, PAni Base and cysteine. PolyDMcT samples produced a pH of 3-4. PANiDMcT samples were consistent, falling in a narrow range of 1.54-1.65. This included a sample made by doping PANi Base with DMcT rather than the one step synthesis and doping of polyaniline with DMcT. Also, “under-doping” the PANi Base did not seem to increase the pH by much. PANiDMcT doped at a ratio of 4:1 aniline units to DMcT had a pH of 1.75. The lowest pH of all was for DMcT itself with a pH of 0.87.

The pH of a CRA can be of importance for two reasons. One is the possibility of acid/base reactions with the binder polymer. The other reason is that if the film is permeable to water, the pH of the solution can influence whether aluminum passivates or corrodes.

TABLE 7
pH of CRA's

| CRA | Lot or Batch # | Comments | pH |
|---|---|---|---|
| Poly-DMcT | ERH 0070 | Iodine process | 3.07 |
| Poly-DMcT | 2005-05191036-105 | Peroxide process | 4.05 |
| Poly-DMcT | 2003-11071013-73 | Peroxide process | 3.51 |
| Poly-DMcT | 2003-13-141 | Peroxide process | 3.75 |
| PAni-DNNSA | 2005-05101038-8 | Estimated 10% | 2.52 |
| | | mixture based on | |
| | | solids | |
| PAni-DMcT | 03-11071014-152 | | 1.65 |
| PAni-DMcT | 2005-05191031-1 | | 1.54 |
| PAni-DMcT | 2003-13-22 | | 1.64 |
| PAni-DMcT (2:1) | 2005-05191036-119 | Made by doping | 1.55 |
| | | PAni base, 2:1 | |
| | | aniline/DMcT | |
| PAni-DMcT (4:1) | 2005-05191031-34 | Made by doping | 1.75 |
| | | PAni base, 4:1 | |
| | | aniline/DMcT | |
| PAni Base | Lot 1E0123 | | 5.51 |
| DMcT | ASV, Lot 1342- | | 0.87 |
| | 06263.04 | | |
| Cysteine | Aldrich, Lot 09807BD | | 5.15 |
| 2-mercapto-4- | Aldrich, Lot 07629DB | | 2.61 |
| methyl-5-thiazol | | | |
| acetic acid | | | |
| 5-amino-1,3,4- | Aldrich, Lot 03210BW | 5% slurry-ran out of | 4.12 |
| thiadiazole-2-thiol | | material | |
| Dipotassium salt of | Alfa Lot# F23Q12 | Completely soluble | 9.26 |
| DMcT | | in water | |

### Conductivity of Bulk CRA

The purpose of this experiment was to test the conductivity of PANiDMcT to compare different lots and the conductivity of the two synthesis methods-doping of PANi Base with DMcT and the one-step polyaniline synthesis and doping with DMcT as described above in Example 1.

Samples were dried to constant weight at 75° C. at <23 torr. 5.0 g of each sample placed in a Streifinger Cell. The cells were pressurized to 8000 psi in a press. Readings were taken with a Fluke 77 multimeter (Resistance across shorted leads=0.3Ω). The conductivity results are presented in Table 8. The bulk PANiDMcT samples are conductive. The sample made with the doping method did have a lower conductivity. Since particle size could play a factor in measurements, it was ground further with a mortar and pestle. This did not make up for the difference in conductivities with the other samples. For reference, it should be noted that a past measurement on PolyDMcT was not obtainable (resistance too high).

TABLE 8
Conductivity of bulk PANiDMcT powders

| Sample | Batch or Lot # | Conductivity (S/cm) |
|---|---|---|
| PAni base doped with DMcT | 2005-05191036-119 | 4.1 × 10⁻⁴ |
| PAni-DMcT | 2005-05191031-1 | 2.0 × 10⁻² |
| PAni-DMcT | 2003-13-22 | 9.2 × 10⁻³ |
| PAni-DMcT | 03-11071014-152 | 3.0 × 10⁻² |
| PAni base doped with DMcT | 2005-05191036-119 | 6.3 × 10⁻⁴ |
| (repeated after grinding) | | |

### Example 4

This illustrates the synthesis of neutralized metal salts of a corrosion-responsive agent.

Zn(DMcT)₂ is formed by dissolving zinc nitrate in methanol and adding this solution to a solution of DMcT in methanol. A precipitate of the formula having the formula Zn(DMcT)₂ forms. Methanol is removed and the product is ground as an aqueous slurry in a jar mill to reduce particle size until a Hegman grind of 5 or higher is achieved. The disodium- or dipotassium-salt of DMcT is then used to increase the pH of the Zn(DMcT)₂ slurry to a range of above 6 and below 8. If this inhibitor is to be used in water-borne coatings, no further work is required. For solvent-borne coatings, the product must be dried and reground/dispersed in an organic solvent such as xylene, again using a jar mill until a Hegman grind of 5 or greater is obtained.

As mentioned above, in order to form the neutralized metal salt of Zn(DMcT)₂, the metal salt is contacted with one or more neutralizing compounds. Useful neutralizing compounds include organic and inorganic bases. Inorganic bases such as NaOH, PO₄⁻³, KOH, LiOH, ammonium, MgOH, and the like can be used as neutralizing compounds. Also, the neutralizing compound can be an alkali metal salt of a thiol or an alkali earth metal salt of a thiol. As an example, Na₂DMcT and K₂DMcT are alkali earth metal salts of a thiol that can act as the neutralizing compound of the present invention.

### Comparative Example 1

This illustrates the formulation of primer coatings that contain the corrosion-responsive agent intermixed with the binder polymer and not in separate first and second domains.

### Set I:

The coatings of this set were spray-applied CRA's in a solvent-borne, high-solids formulation. The CRA was intermixed with an epoxy resin that was a mixture of Epon 1001 and Epon 1007. The polyamide curing agent was Epikure 3213. The clear coats were formulated so that incompatibilities between resin and inhibitor would be more readily apparent. In a special subset of this formulation, DMcT was added to Epon 1009 resin without using additional curing agent, the desired outcome being a lack of reactivity with DMcT. However, this system appeared to lack the solvent resistance required by military specifications.

### Formulations:

High solids, solvent-epoxy with a polyamide curing agent; Blend of

Epon 1007 and Epon 1001 epoxies;

Epikure 3213 curing agent;

Epon 1009 (with DMcT only);

10% concentrations of non-chrome CRA's based on solids. This is approximately equal to 6% by weight total resin solids; and

Other pigments such as TiO₂ and Zn₃(PO₄)₂ included in the same quantities as the non-chrome standard.

CRA solids were ground in jar mill prior to addition to formulation. Post-addition technique used.

The spray-applied primers consisted of:

Deft chromated epoxy primer (commercially available);

Chromate epoxy primer control;

Non-chrome control;

PANiDMcT in non-chrome formulation;

PANI base doped with DMcT (2:1) in non-chrome formulation;

Poly-DMcT in non-chrome formulation;

Clear-coat with PANI-DMcT;

Clear-coat with PANI base doped with DMcT (2:1);

Clear-coat with poly-DMcT; and

Most of the formulations were applied to all of the following substrates:

CCC 2024-T3 for corrosion and dry tape adhesion testing (Wagner Rustproofing, Cleveland, Ohio);

HD Zn galvanized steel for corrosion testing;

bare cold roll steel for corrosion testing;

deoxidized Al-clad 2024-T3 for wet tape adhesion testing; and

Anodized 2024-T0 for flexibility tests (MetaSpec of San Antonio, Tex.)

### Results and Discussion: Testing of Primer Formulations

### Compatibility Testing

In these experiments, individual components were mixed in various combinations with the present CRA's. Individual resin components included the epoxies, the amine-based hardeners, a flow control additive, and a surfactant-type additive. Inhibitors included poly-DMcT, PANiDMcT, DMcT, and PANi-DNNSA. The formulations were observed for problems such as CRA flocculation.

Compatibility testing showed that of the formulation components, the amine-based curing agents, such as Epikure 3175, are probably the most responsible for the flocculation of poly-DMcT. PAni based CRA's did not flocculate as badly, but they did exhibit dedoping as suggested by a green to blue color change. Also, there was no measurable conductivity. (Lack of conductivity may not be entirely due to dedoping, but also to the CRA particles being entirely encapsulated by insulating resin.) This appears to be a fundamental problem for the room temperature cure epoxies because of the basic, amine containing curing agent reacting with the acidic CRA's. Possible ways of overcoming the problem include encapsulation of the CRA, modification of the CRA to make it less acidic/reactive, or a layered coating approach where alternating layers of CRA and binder polymer are applied separately.

### Application Observations:

Coating thicknesses were highly variable, both between specimens and across the surface of individual specimens. On randomly selected individual panels, coating thicknesses could vary by a factor of 2× to 3×. Coatings ranged from approximately 1 mil to over 3 mils.

Many of the coatings showed an orange peel effect.

Panels were analyzed under low magnification optical microscopy. For primers less than two mils thick, there was a problem with pinhole defects that left some of the substrate exposed.

Both PANiDMcT and PAni base doped with DMcT formulations appeared to be blue. The green color of some of the coatings was an illusion caused by a translucent blue film over a yellowish (chromate conversion coating) background.

The fully formulated PANiDMcT primers have a bluish cast, presumably from the inhibitor being dedoped or deprotonated. This is inferred from the color change with the corresponding clear coats described in the previous bullet.

The clear coats were largely unusable for testing because of the excessive number of bubbles in the dried film.

Salt Spray:

Spray-applied primers and draw-down bar applied primers were tested according to MIL-PRF-2377J, section 4.5.8.1 and ASTM B117. A Q-Fog SSP600 (Q-Panel) cabinet was used for salt spray exposure. Primers were applied to chromate conversion coated 2024-T3 substrate and allowed to cure for a minimum of two weeks at ambient conditions prior to scribing and testing. To promote better adhesion between the primer and conversion coating, primer application was performed within three to four days of conversion coating application.

A commercially formulated chromate control and a chromate control that was formulated in-house were passing after 500 hours and were left in the chamber to continue testing. The purpose of this is to verify the quality of the in-house formulated chromate control. The performance of these two formulations was approximately equal at the end of 500 hours.

None of the non-chromate primers equaled the performance of the chromate controls, and all had failed at 500 hours. Consequently, these panels were removed from salt spray. The performance of the panels containing the present non-chrome inhibitors was equivalent to the non-chrome control. Most of the non-chrome primers exhibited equivalent performance, except for the “clear” coats which showed greater variability and a lower performance than the fully pigmented coatings.

### Reverse Impact Testing

The Reverse Impact Test was performed in accordance with MIL-PRF-2377J, section 4.4.1 using a Gardco IM-172 reverse impact tester (Paul N. Gardner Co., Inc.). All coatings tested were applied with a drawdown bar. The coatings were allowed to cure for two weeks under ambient conditions prior to testing. Coating thicknesses were also recorded prior to testing.

### Adhesion Testing

Dry tape adhesion testing was performed according to ASTM 3359, Method B on primer coatings applied to chromate conversion coated 2024-T3. Cross hatch scribe pattern was made with a 107 Cross Hatch Cutter (Elcometer). Coating thickness for test was also measured and recorded using a PosiTector 6000 Coating Thickness Gage (DeFelsko).

All samples passed wet tape adhesion. All samples rated 5B on dry tape adhesion, the highest possible rating. “Clear coats” were not tested.

### Flexibility Testing:

No samples passed flexibility, including commercial chromated control, in-house formulated chromate control, and non-chrome control.

### Other Observations/Unexpected Results:

The clear coats with PANiDMcT were blue, indicating a deprotonation or dedoping of the polyaniline. This is likely the cause of the bluish cast of the fully pigmented formulations.

### Example 5

This example illustrates tests conducted in order to overcome the negative interactions between inhibitors and the resin.

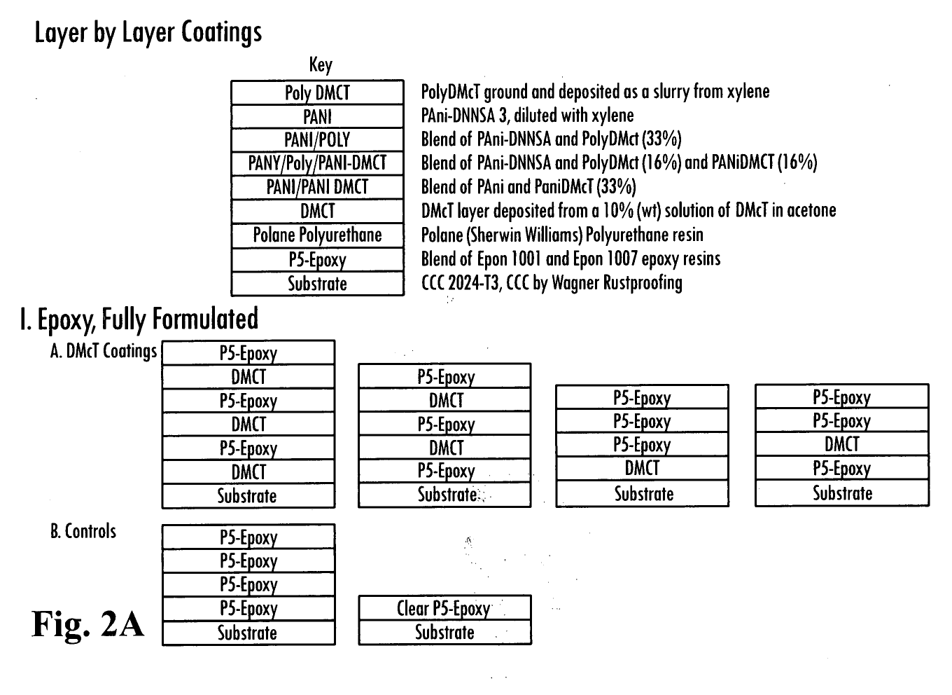

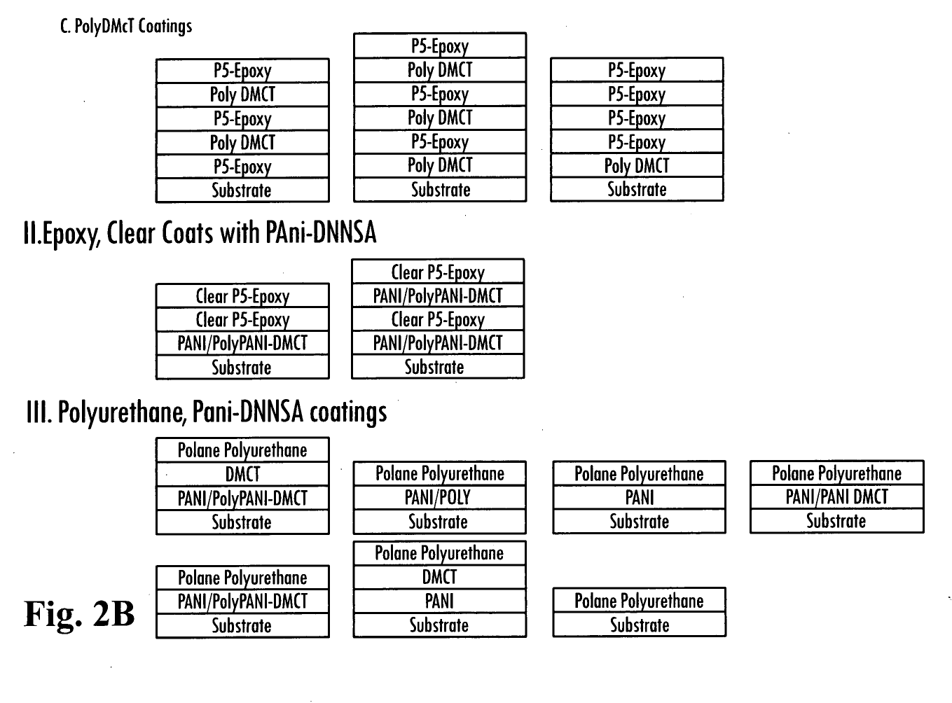

The general design was to apply the CRA and the resin layers separately so that their interaction in the uncured system is minimized. As an example of the layered coatings, see the coating schemes given for this set in FIG. 2. The layer-by-layer coating approach minimized incompatibility problems between the epoxy resin and the CRA's and reduced or eliminated undesirable reactions that could compromise film properties, complicate inhibitor dispersion, and decrease availability of the CRA's to prevent corrosion. Layering schemes included alternating layers of epoxy with CRA's such as DMcT or PolyDMcT.

Another purpose of the layer by layer work was to produce a conducting film having layers that contained high levels of CRA's. To that end, PANi-DNNSA 3 (Polyaniline formulation available from Crosslink, St. Louis, Mo.) was applied to aluminum substrates and topcoated with polyurethane. The polyurethane resin was selected because it was more compatible with the PANi-DNNSA 3 than epoxy. The PANi-DNNSA 3 films were loaded with PANiDMcT, polyDMcT or combinations of both.

### Formulations:

High solids, solvent-epoxy with a polyamide curing agent: Blend of Epon 1007 and Epon 1001 epoxies;

Epikure 3213 curing agent; and

Other pigments such as TiO₂ included in the same quantities as the non-chrome standard;

Binder polymer and CRA coating formulations were applied by spin coating 3″×3″ panels at 500 rpm. Solvents were flashed off at 80° C. for about 15 minutes between coating each layer, both the paint and the inhibitor, except for the DMcT layers. The DMcT layers dried rapidly in air without heating.

Most formulations were applied to CCC 2024-T3 for corrosion testing. Prior to corrosion testing, coated panels were scribed with a mechanical scriber and taped with electroplater's tape. Corrosion testing was performed according to ASTM B117. Thickness measurements made with a Positector 6000-N2 (DeFelsko)

Salt spray results from the layer-by-layer approach were a great improvement over directly formulating the same CRA's into epoxy as described in the Comparative Example above. Two different sets of three panels each, both sets using alternating layers of PolyDMcT with epoxy, were passing salt spray testing at 1600 hours. One set was considered to be passing with two out of three panels performing well at 2000 hours of salt spray exposure.

PANi films (PANi-DNNSA 3) topcoated with epoxy or polyurethane did not perform well, whether a CRA was included or not. Polyurethane formulations were used instead of epoxy because the polyurethane did not appear to dedope the PANi-DNNSA film. PANi-DNNSA films coated with polyurethane remained green, while a PANi-DNNSA film coated with epoxy would turn blue within seconds of the epoxy being applied.

Continued salt spray results showed that the layer-by-layer approach were a great improvement over directly formulating the same inhibitors into epoxy. One set of three, using alternating layers of polyDMcT with epoxy, was passing at 2000 hours. At 3000 hours, the results still appeared promising, but because of a small amount of pitting in the scribes, these panels were removed from testing.

### Example 6

This example illustrates the improvement in active corrosion inhibition of a scribed, BAM-PPV coated panel and to show the value of BAM-PPV as a binder for Crosslink's inhibitors, including as a direct to metal primer formulation.

This experiment used layering schemes as described in Example 5. CRA's were mixed with 1% BAM-PPV solutions in xylene. These solutions were applied to 2024-T3 substrate (both bare and having a chromate conversion coating), dried, and then coated again with 1% BAM-PPV solution. See FIG. 2 for examples of the coating schemes. CRA's included DMcT, polyDMcT, and PANiDMcT. Panels were scribed and tested for corrosion resistance according to the ASTM B117 salt spray method.

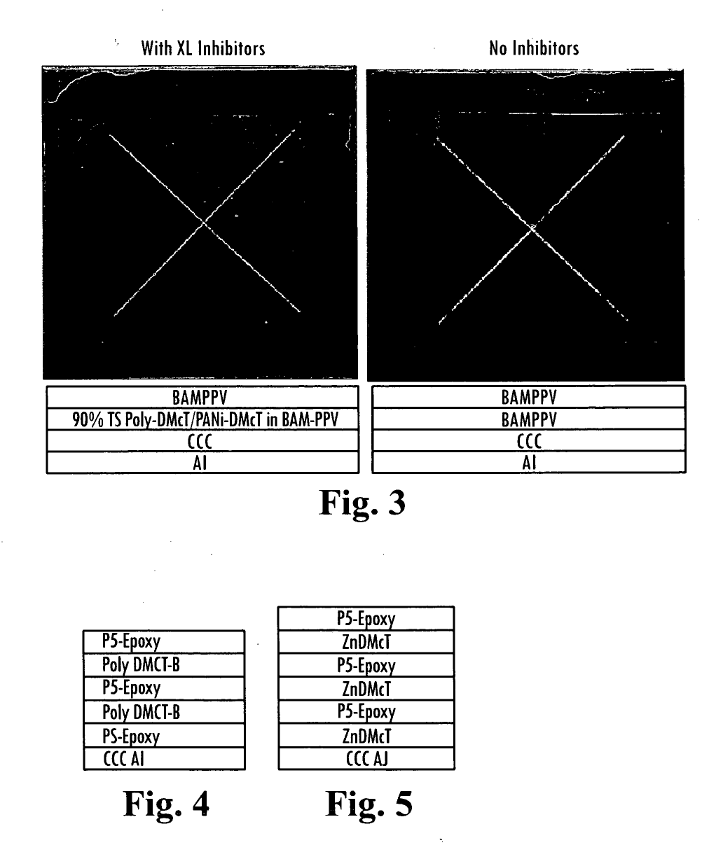

Salt spray results for this layering system were not as good as the best results shown for layered coatings described in Example 5. However, there were signs of corrosion inhibition as compared to the blank formulations. The best performer contained a high loading of a mixture of PANiDMcT and polyDMcT (1:1 ratio) in the first coating layer. FIG. 3 shows a comparison of this coating scheme with the control. The control shows much more corrosion products in the scribe and salt bleeding out of the scribe.

### Example 7

This illustrates a replication of spin-coated samples described in Example 5, and the application of similar, layer-by-layer systems with a spray gun.

Most formulations in this example were similar to, or variations of, the formulations described in Example 5. Additionally, some coatings contained neutralized Zn(DMcT)₂, as described in Example 4. Another difference between the coatings in this example and those of Example 5 is that many of the formulation schemes were spray applied in this set, rather than spin coated or applied with a draw-down bar. Some of these were also sprayed “wet-on-wet”, meaning that the layers were not given time to dry between applications of each layer in a manner similar to methods now used to coat aircraft.

### Testing of Formulations

### Salt Spray Testing

Spray-applied primers and draw-down bar applied primers were tested according to MIL-PRF-2377J, section 4.5.8.1 and ASTM B117. A Q-Fog SSP600 (Q-Panel) cabinet was used for salt spray exposure. Primers were applied to chromate conversion coated 2024-T3 substrate and allowed to cure for a minimum of two weeks at ambient conditions prior to scribing and testing. To promote better adhesion between the primer and conversion coating, primer application was performed within three to four days of conversion coating application.

One finding was that the layered coating schemes could be applied by spray application as well as a spin coat application. Also, it was possible to apply layers “wet-on-wet”, i.e. layers were applied over each other without drying between layers. This could make the layered coating approach a much more practical solution to the problem of inhibitor/resin incompatibility.

Before primer application, CCC's were tested for water breaks and for dilute acid resistance (4% nitric acid drop placed on the chromate conversion coating for ten minutes should not damage the CCC).

Results from these tests showed:

Neutralized Zn(DMcT)₂ was used in the layered coatings, and it produced some of the best results. Three out of three panels were passing at 880 hours of salt spray exposure and are still in testing.

The other successful performer in this set contained polyDMcT. It was spin-coated and dried between layers according to the scheme in FIG. 4. Two out of three panels were passing at 880 hours from this set.

Another interesting observation was that the coating scheme in FIG. 8 performed better than those in which the polyDMcT was in direct contact with the conversion coating. Research found evidence that DMcT interacts with the chromate conversion coatings. It was believed that the chromate conversion coating could negatively affect the polyDMcT or the DMcT released from polyDMcT, PANiDMcT, or any other source of this CRA.

Two sets of three phosphated steel panels each were spray coated. One set was a blank control; the other contained a layer of polyDMcT sandwiched between two layers of primer. The polyDMcT coatings showed a significant improvement in corrosion resistance as compared to the control.

A successful spray applied primer contained DMcT. This was a departure from earlier tests where polyDMcT performed well. However, the spray applied DMcT containing coatings did not perform as well as the aforementioned polyDMcT containing coatings.

In the layered coatings, DMcT may still be able to migrate through the subsequent primer layers. On the spray applied panels, yellow areas were observed on the light gray primer. In these yellow areas, there were adhesion failures, while the areas that did not show the yellow tint passed the adhesion tests. The DMcT layer is likely being resolubilized by the solvents in the primer formulation.

Non-chromated primers applied to bare aluminum (without chromate conversion coating) did not perform as well as when they were applied over chromate conversion coated aluminum.

### Example 8

This illustrates a replication of spin-coated samples described in Example 5, and the application of similar, layer-by-layer systems with a spray gun as described in Example 7.

The binder polymer used was a solvent-borne, high solids formulation falling under MIL-PRF-23377J. The components for Part A included Epon 1007-HT-55, Epon 1001-B-80, additives, pigments and solvents. Part B included Epi-cure 3213 and solvents. Parts A and B were mixed and applied between thirty minutes and four hours after mixing. The primer formulation, without inhibitor, was as shown below in Table 9.

TABLE 9
Solvent-borne epoxy primer (P5), non-chromated.

| | | | | Density | Density | | | Volume | |
|---|---|---|---|---|---|---|---|---|---|
| | Material | Grams | Wt. % | (lbs/gal) | (g/ml) | % Solids | Solids | (Solids) | 2x |
| Part A | EPON 1007-HT-55 | 105.00 | 18.22 | 8.60 | 1.03 | 55.00 | 57.75 | 59.60 | 210.00 |
| | EPON 1001-B-80 | 62.50 | 10.84 | 9.20 | 1.10 | 80.00 | 50.00 | 55.00 | 125.00 |
| | Anti-Terra U | 0.66 | 0.11 | | | | | | 1.32 |
| | Xylene | 16.67 | 2.89 | | | | | | 33.33 |
| | Ektasolve EEP | 20.00 | 3.47 | | | | | | 40.00 |
| | Ti Pure R706 | 90.00 | 15.61 | 33.00 | 3.96 | 100.00 | 90.00 | 22.73 | 180.00 |
| | ZP-10 Zinc Phosphate | 0.00 | 0.00 | 27.52 | 3.30 | 100.00 | 0.00 | 0.00 | 0.00 |
| | Sparmite Barium Sulfate | 90.00 | 15.61 | 36.56 | 4.39 | 100.00 | 90.00 | 20.51 | 180.00 |
| | Zeeosphere 400 | 90.00 | 15.61 | 18.30 | 2.20 | 100.00 | 90.00 | 40.98 | 180.00 |
| | Water Ground Mica 325 Mesh | 10.00 | 1.73 | 25.00 | 3.00 | 100.00 | 10.00 | 3.33 | 20.00 |
| | Ball Mill to Hegman 7 | | 0.00 | | | | | | |
| | Xylene | 19.40 | 3.37 | | | | | | 38.80 |
| | | | 0.00 | | | | | | 1008.45 |
| Part B | EPI-CURE 3213 | 31.95 | 5.54 | 8.06 | 0.97 | 100.00 | 31.95 | 30.91 | 63.90 |
| | MEK | 20.80 | 3.61 | | | | | | 41.60 |
| | Isopropanol | 19.45 | 3.37 | | | | | | 38.90 |
| | | 576.43 | 100.00 | | | | | | 144.40 |

| | | |
|---|---|---|
| % PVC = (pigment vol × 100)/(pig vol + resin volume | PVC | 37.57 |
| solids) | | |

BMDCInk P5 Primer
9 grams A + 3 grams B + butylcellosolve for viscosity adjustment

Most of these formulations were similar to, or variations of, formulations used in Example 5. Additionally, some coatings contained neutralized Zn(DMcT)₂.

Another difference between this set and the coatings described in Example 5 is that many of the formulation schemes were spray applied in this set and some of these were also sprayed “wet-on-wet”.

Neutralized Zn(DMcT)₂ was used in the layered coatings, and it produced successful results. An example of a layered coating containing modified Zn(DMcT)₂ is shown in FIG. 5. Three out of three panels were passing at 2500 hours of salt spray exposure. This was in spite of poor distribution of the inhibitor across the panel surface as layers were applied. Additional work with this inhibitor used spray application of inhibitor slurries in xylene.

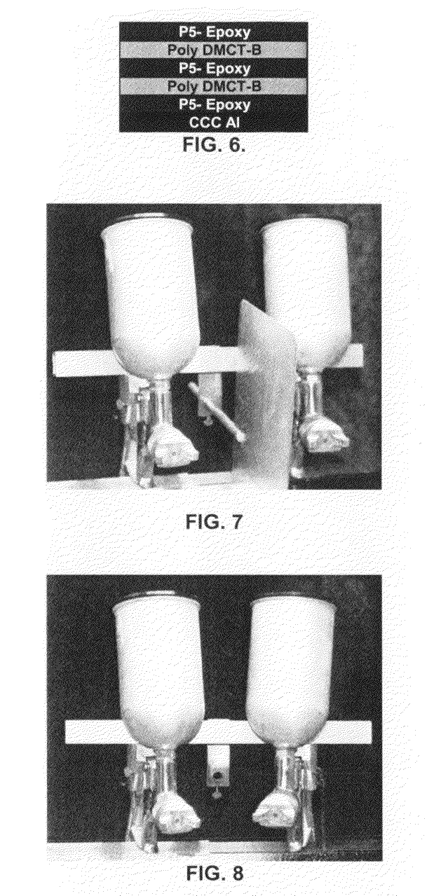

The other successful performer in this set contained polyDMcT. It was spin-coated and dried between layers according to the scheme in FIG. 6. Two out of three panels were passing at 880 hours, and one out of the three passed for 2000 hours before failing at 2500 hours.

### Example 9

This example illustrates the application of coatings of an embodiment of the present invention by spraying using either a layered scheme or a composite scheme in which two separate sprays were applied simultaneously to obtain a composite coating.

Goals of this test were to: use a spray application to reproduce the best layered coatings from those described in Example 5 which had been originally applied by spin coating, use a dual spray-gun set-up to make the layered approach more practical by applying the layers with the same apparatus, modifying the dual spray gun to test whether or not mixing the resin and the inhibitor spray streams would work as well as applying the resin and inhibitor in separate layers-coatings could be applied in a single layer using this system, including neutralized Zn(DMcT)₂ in spray-applied coatings, and by allowing panels to cure at room temperature for two weeks prior to testing instead of using an accelerated cure schedule

### Formulations/Application

The primer was of the same formulation as described in Examples 5 and 7. The coatings were applied from two gravity fed spray-guns mounted to a bar about eighteen inches in length. With this configuration, both guns could be operated simultaneously. One gun contained the high-solids epoxy primer while the other gun contained a slurry of the CRA which had been ground and dispersed in xylene. For those coatings with multiple layers, a partition was put in place between the spray streams of the guns (See FIG. 7). For primer coatings applied as mixed sprays, the partition was removed and the spray-guns were angled inward towards each other (FIG. 8). Various coating schemes contained four non-chrome inhibitors-DMcT, polyDMcT, PANiDMcT and neutralized Zn(DMcT)₂. Also included was a set of chromate controls spray-applied in a conventional manner.

### Salt Spray Testing

The coatings in this example were designed to follow-up promising results of spin-coated specimens described in Examples 5 and 7. The coatings described in Example 7 included the first attempt at layering the coatings with a spray application. Unfortunately, the spray-applied coatings in that example performed poorly in salt spray tests. The salt spray results from the present experiment were much better through the first 1000 hours of testing.

Important findings:

“Mixed spray” with PANiDMcT worked best, followed by multiple layers of PolyDMcT;

The mixed spray coating scheme was easier to apply than the multi-layered primers;

Neutralized Zn(DMcT)₂ in a multi-layer system showed promising results. One panel out of three was passing at 1000 hours, but of the two failing panels, one had a defective scribe which appears to be related to the failure;

PANiDMcT only worked well in the mixed spray approach. It did not show good inhibition in the layered approaches;

In the layered approaches, a coating scheme with a single layer of inhibitor followed by a single layer of primer did not work as well as multiple, alternating layers;

The chromate control primer did not provide any more inhibition than the top performing primers from this set;

While many panels technically failed between the 500 hour and 1000 hour marks, many of these were failed because of barely detectable areas of salting in the scribes. These areas comprised less than a few percent of the scribe length, yet the rest of the scribe was perfectly shiny; and

Blistering was scarcely a problem with this set, unlike in Example 7. This may be because of better chromate conversion coatings or because of curing panels two weeks at room temperature rather than accelerating their cure at elevated temperature.

Flexibility testing:

Flexibility testing was problematic for this set. The coatings containing non-chrome CRA's failed while the chromate control and one of the negative (no CRA) controls passed. At first glance, the failures appear to be related to whether or not the coating contained a non-chrome CRA; however, coating thickness may have played a large role in what passed or failed. The negative control was tested in two different versions, a single layer and a thicker, multi-layer coating. The recommended coating thickness range by the military specifications is 0.6 to 0.9 mils. The single layer coating, which passed, had a coating thickness of 0.5 mils. The multi-layer coating, which failed, had a coating thickness of 1.4 mils. The chromate control, which passed, had a coating thickness of 0.4 mils. Two of the coatings containing non-chrome CRA's came very close to passing and were noted as borderline failures. The thicknesses of these two coatings fell within the range recommended by the military specifications and were thus thicker than the two control coatings which passed. For this reason, it is believed that the CRA's are having little, if any, detrimental impact on flexibility, and that the flexibility failures may be dealt with by adjusting the formulation.

### Adhesion

All specimens tested passed the dry tape adhesion test.

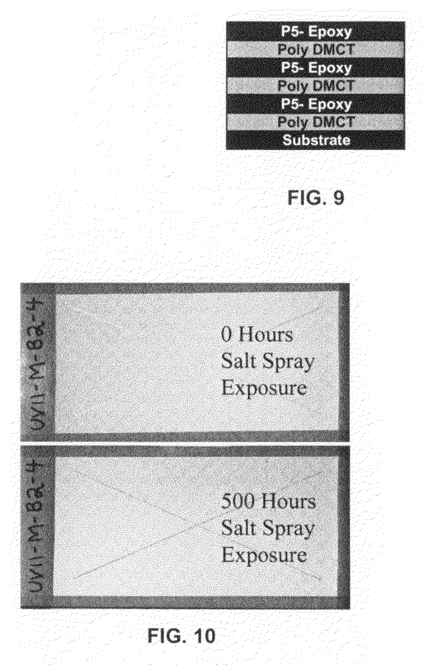

Results from the wet tape adhesion tests may not have been accurate, but they may have proven that good adhesion is still attainable with the layered coating approach. All but one coating system failed. The coating scheme for the passing specimen which contained polyDMcT is shown in FIG. 9. The failures included the chromate and negative controls. For this reason, it is suspected that something was performed improperly during the coating application or test, perhaps during the surface preparation prior to painting. The specimen represented by FIG. 9 would be expected to have the most difficulty passing the adhesion test considering the potential weakness of the inhibitor layer that is immediately adjacent to the substrate. Despite the problems, the results suggest that good adhesion results are attainable for the multi-layer systems.

Continued testing of coatings of this example resulted in the following findings:

Through the first 1000 hours, “Mixed spray” forming a composite coating with PANiDMcT worked best overall, followed by multiple layers of polyDMcT. After the 1500 and 2000 hour mark, performance of the mixed spray PANiDMcT panels faded quickly. There seemed to be a slight change in color during this time. If this color change is due to dedoping, then the color change may correlate with deteriorating corrosion protection because dedoping means that the inhibitor has been depleted. The performance of the best neutralized Zn(DMcT)₂ sets was not as good over the first 1000 hours, but they held up better than either the polyDMcT or the PANiDMcT beyond the 2000 hour mark.

In the mixed spray method alone, neutralized Zn(DMcT)₂ and PANiDMcT produced the best results. PANiDMcT was comparable to the chromate controls for the first 1500 to 2000 hours before degrading significantly. The mixed spray Zn(DMcT)₂ lasted longer and was comparable to the chromate controls at 3000 hours when the test was terminated.

PANiDMcT only worked well in the mixed spray approach. It did not show good inhibition in the layered approaches.

In the layered approaches, a coating scheme with a single layer of inhibitor followed by a single layer of primer generally did not work as well as multiple, alternating layers.

The chromate control primer did not provide any more inhibition than the top performing primers from this set.

While many panels technically failed between the 500 hour and 1000 hour marks, many of these were failed because of barely detectable areas of salting in the scribes. These areas comprised less than a few percent of the scribe length, yet the rest of the scribe was perfectly shiny.

### Example 10

This example illustrates tests in which the concentration of the CRA was controlled in composite spray applied coatings.

The non-chrome primer mill base and the spray apparatus were similar to those used in Example 8 for mixed sprays.

The work concentrated on three CRAs: PANiDMcT, PolyDMcT and neutralized Zn(DMcT)₂. Various concentrations of these CRA's were applied to chromate conversion coated 2024-T3 (salt spray, dry tape adhesion) and anodized 2024-TO (flexibility). Three of the most promising non-chromate coating formulations were chosen for expanded testing. Additional variables were aluminum alloy, alloy pretreatment and application of topcoat. The variations and tests are given in Table 10. A commercially available chromate control primer was also included in each test.

TABLE 10
Substrate, pretreatment and designated tests for advanced
testing of non-chromate CRA formulations.

| | | Topcoat | |
|---|---|---|---|
| Substrate | Pretreatment | (Y/N) | Designated Tests |
| 2024-T3 | CCC | N | Salt Spray, Dry Tape |
| | | | Adhesion |
| 2024-T3 | CCC | Y | Salt Spray |
| 2024-T3 | BAM-PPV | N | Salt Spray, Dry Tape |
| | | | Adhesion |
| 2024-T3 Al- | Deoxidized | N | Wet Tape Adhesion |
| clad | | | |
| 2024-T3 Al- | CCC | Y | Filiform corrosion Test |
| clad | | | |
| 2024-T0 | Anodized, Cr | N | Flexibility |
| | seal | | |
| 7075-T6 | CCC | N | Salt Spray |

Notes: BAM-PPV pretreatment was supplied by NAVAIR in China Lake, Calif. Chromate conversion coatings were applied by Wagner Rustproofing of Cleveland, Ohio. Chromic acid anodizing was performed by Alexandria Metal Finishers of Lorton, Va. Panels with topcoats were painted with a solvent-borne polyurethane, Deft 03-W-127A, batch # 66539. The polyurethane topcoat was applied 4½ to 5 hours after primer application.

### Infrared Spectroscopy

IR spectra were recorded with a Perkin Elmer, Spectrum One FTIR using the Golden Gate Sampling Accessory for reflectance measurements. Samples tested included PANiDMcT, polyDMcT, and DMcT Dimer.

### Gravimetric Analysis

The purpose of this experiment was to determine the amount of polyaniline in the PANiDMcT product. PANiDMcT was initially ground to a fine powder with a mortar and pestle. Four 0.20±0.01 g of PANiDMcT samples were soaked one to four days in 50 mL of 0.1 M NaOH. Sodium hydroxide solution volume provided a molar excess of NaOH to the amount of DMcT and DMcT derivatives in PANiDMcT sample. One sample was taken, filtered and rinsed on each successive day. Solid residues were analyzed by IR and determined to be PANi base. The combined filtrate and rinse water from each sample was set aside.

### Gel Permeation Chromatography

GPC efforts centered on review of the methods utilized previously for analyzing polyDMcT and PANiDMcT. One of the tested samples included the solid residues from the PANiDMcT gravimetric tests described above. Also tested was polyDMcT and the DMcT monomer.

### Elemental Analysis

Samples of polyDMcT and Zn(DMcT)₂ were sent to an outside analytical laboratory for analysis.

### Sulfate Analysis

A potential contaminant of the PANiDMcT product is sulfate. Sulfate is produced in the synthesis from the reduction of ammonium peroxydisulfate which is used as the oxidizer for the polymerization reaction. Sulfate may be difficult to remove in the washing steps because it is either entrapped in PANiDMcT particles or it is incorporated into the PANi as a dopant. Sulfate as sulfuric acid could contribute to the high acidity of the PANiDMcT, and sulfate dopant would reduce the amount of DMcT dopant available for release.

Sulfate analysis was performed by an outside analytical laboratory using an ion chromatography technique with conductivity detectors. Two samples were submitted—the combined filtrate and rinse water from the one day and the four day experiments described in the gravimetric analysis section above.

### Energy Dispersive Spectroscopy

EDS of DMcT was performed in an environmental SEM. The goal was to test if EDS could obtain elemental analysis data for N, S, and O.

Salt Spray Testing (ASTM B117) at 2000 Hours of Exposure

Salt spray testing encompassed the aluminum alloys of 2024-T3 and 7075-T6. Pretreatments included chromate conversion coatings and a BAM-PPV non-chromate conversion coating. Also, topcoated primer specimens were added to the test. A summary of results of salt spray testing at 2000 hours is provided below. One of the most significant findings is that the best performer in salt spray testing was a non-chromate primer applied to BAM-PPV. This chromate free system performed better than the corresponding chromate controls. The chromate control for this set was a commercially available, solvent-borne primer from Deft which meets the 23377J specifications for a chromate primer.

### CCC 2024-T3:

The best performers on CCC 2024-T3 are sets of PANiDMcT and neutralized Zn(DMcT)₂ primers. Five sets of PANiDMcT primers were tested. The highest inhibitor concentration was about 29% by wt of solids and the lowest was about 14%. These two sets and another at 15% were the lowest performers. The mid-range concentrations of 17% and 21% gave the best performance. The 17% concentration gave the most passes out of any of the test sets on CCC 2024-T3, including the chromate controls. It appears that the lower concentrations fall off in performance more than the higher concentrations, but there is also a limit to the highest concentrations possible. In dry tape adhesion testing, it appeared that some of the inhibitor may have been physically removed from the coating containing 29% PANiDMcT. Lower salt spray performance may have been related to this problem. Three sets of Zn(DMcT)₂ have performed well relative to the chromate controls, but at 1500 hours of exposure, only one panel from one set was passing. PolyDMcT was included in two sets. Neither of these sets has performed as well as the chromate controls.

CCC 2024-T3, with Topcoat:

The results with topcoated primers were surprising in that nothing, including the chromate control, was passing after 500 hours of exposure. However, the neutralized Zn(DMcT)₂ primer did perform as well as the chromated primer. The two PANiDMcT sets had many tiny blisters in the field. One change that could improve performance is the application of a second layer of topcoat to increase its thickness.

### CCC 7075-T6:

On CCC 7075-T6 the best performer of the four sets-including Cr control—was a set of neutralized Zn(DMcT)₂ primers. These produced passes up to 1000 hours before failing at 1500 hours. The chromate controls were a close second, also passing at 1000 hours before failing at 1500 hours. The degradation of the chromate controls at 1500 hours was more severe than that of the neutralized Zn(DMcT)₂ primers. The two PANiDMcT primer sets were failed and removed from salt spray at 500 hours.

### BAM-PPV Pretreated 2024-T3:

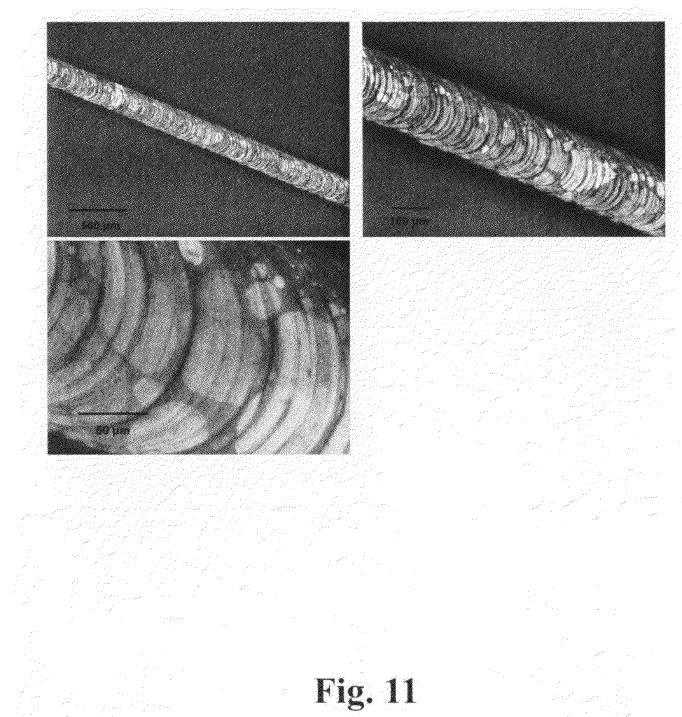

The best CRA performer in this set was neutralized Zn(DMcT)₂. This set passed at 2000 hours and showed that a chromate free system provided better corrosion protection than chromated paint systems. FIG. 10 shows the darkening of the scribe that occurred after just 500 hours of salt spray exposure. The scribes are progressively turning more orange/red over time. In the inventor's experience, this kind of color change is sometimes the result of microscopic pitting. FIG. 11 shows optical micrographs of a scribe after 1500 hours of salt spray exposure. The color does not appear due to microscopic pitting. Instead, it may be possible that a coating is forming in the scribes. Characterization of the passivating materials in the scribe may be the subject of future analytical work.

Interestingly, this set performed better than the set which had the same neutralized Zn(DMcT)₂ primer applied over chromate conversion coated substrate. DMcT can react with the chromate conversion coating and thus compromise the corrosion protection provided by DMcT. The BAM-PPV pretreatment may not interact with the inhibitor, or it may interact in a positive way.

The PANiDMcT primers and the chromate control blistered badly. Also, the dry tape adhesion test produced adhesive failures between the pretreatment and the substrate. The supplier of the non-chromate pretreatment has been contacted. The surface prep prior to pretreatment may need to be changed to accommodate the 2024-T3 substrate. It is thought that improvements in adhesion would improve corrosion resistance and alleviate blistering.

### Filiform Corrosion Test

All panels tested for filiform corrosion passed. These included the chromate control primer, two PANiDMcT primers and a neutralized Zn(DMcT)₂ primer.

### Adhesion Testing

In the dry tape adhesion tests, all fourteen coatings applied to chromate conversion coated 2024-T3 received the highest rating, 5B. Lower ratings were obtained for three out of four coatings applied to BAM-PPV pretreated 2024-T3. The lower ratings extended to the chromate control as well. Adhesive failures were observed between the pretreatment and the substrate rather than the pretreatment and the primer.

In wet tape adhesion testing, only the chromate control passed. One of the three non-chromate panels tested failed with only about 10-20% film removal. Incidentally, this also had the best adhesion to BAM-PPV in the dry tape adhesion test. This test will be modified in the future. The substrate used up to this point was deoxidized, Al-clad 2024-T3, the substrate specified in Mil Spec 23377, however, this test may be more appropriate for use with chromate conversion coated 2024-T3 as the substrate.

### Flexibility Testing

Seven out of nine coating formulations passed the flexibility test. The failures were the neutralized Zn(DMcT)₂ primer and the chromate control. These two primers were spray applied at a thickness greater than the recommended 0.9 mils and had the highest dry film thicknesses of the nine coatings tested. Reducing the film thickness should improve the passing rate.

### Analytical Characterization of Inhibitors

### Infrared Spectroscopy

Spectra for PolyDMcT from different batches indicate some variation in composition. A comparison of the spectra of sample #1 and sample #2 showed an interesting feature that is common to both is the position of peaks around 1705-1710 cm⁻¹. These peaks are not present in the monomer. Peaks in the range of 1690 to 1760 cm⁻¹ are often assigned to carbonyl groups. If the peak is indeed a carbonyl, then this indicates the presence of entrapped solvents, such as acetone, or undesired by products. Also, sample #1 has a peak at 1652. This occasionally shows up in other spectra of polyDMcT. One possibility is that conjugation with other functional groups has lowered the wavelength at which the carbonyl absorbs. Other possibilities include anyone of several combinations of C═N stretching with other functional groups attached. Interestingly, one reference mentions that DMcT degrades when mixed with acetone or methyl ethyl ketone.

### Elemental Analysis

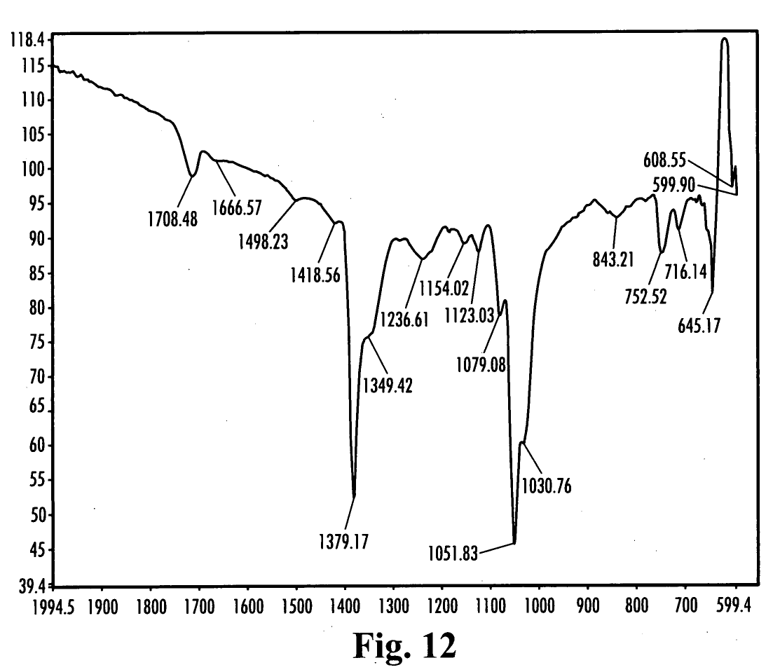

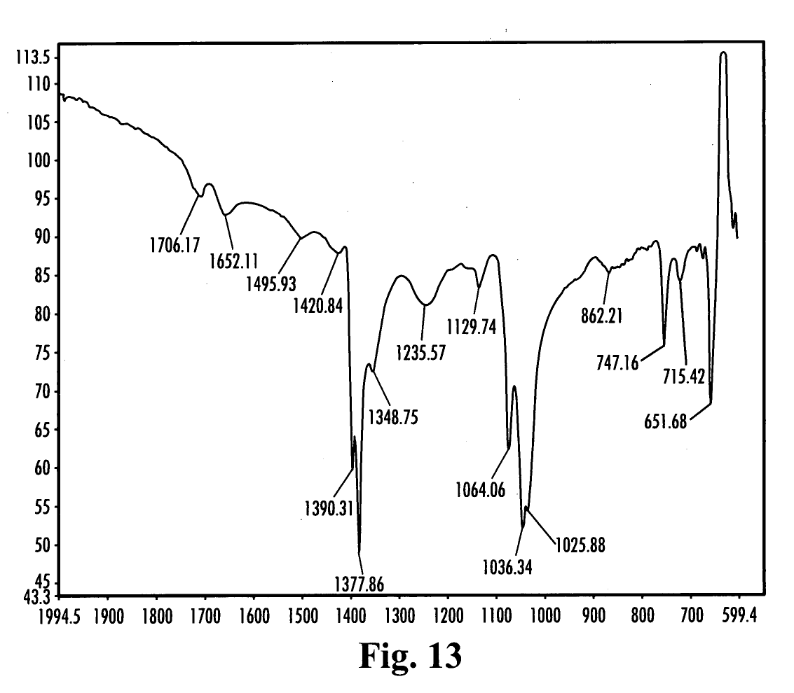

The analyses of two polyDMcT samples and one neutralized Zn(DMcT)₂ sample are presented in Tables 11-13. The two polyDMcT samples were chosen because they represented two of the most dissimilar samples according to IR. These two IR spectra are shown, respectively, in FIG. 12 and FIG. 13.

TABLE 11
Elemental analysis of PolyDMcT, sample #1.

| | Theoretical % | Experimental % | Difference |
|---|---|---|---|
| Element | mass | mass | (% Exp. − % Th.) |
| Carbon | 16.19 | 17.46 | 1.27 |
| Hydrogen | 0.10 | Not Detected* | — |
| Nitrogen | 18.88 | 18.76 | −0.12 |
| Oxygen | 0.00 | — | — |
| Sulfur | 64.83 | 62.11 | −2.72 |
| Totals | 100.00 | 98.33 | |

TABLE 12
Elemental analysis of PolyDMcT, sample #2

| | Theoretical % | Experimental % | Difference |
|---|---|---|---|
| Element | mass | mass | (% Exp. − % Th.) |
| Carbon | 16.19 | 17.13 | 0.94 |
| Hydrogen | 0.10 | Not Detected* | — |
| Nitrogen | 18.88 | 18.71 | −0.17 |
| Oxygen | 0.00 | — | — |
| Sulfur | 64.83 | 62.75 | −2.08 |
| Totals | 100.00 | 98.59 | |

*Detection limit for hydrogen is 0.5%.

TABLE 13
Elemental analysis of Zn(DMcT)₂ prior to neutralization

| Element | Experimental % mass | Molar Ratio |
|---|---|---|
| Carbon | 13.23 | 1.10 |
| Hydrogen | 0.64 | 0.63 |
| Nitrogen | 15.04 | 1.07 |
| Oxygen | 0.00 | na |
| Sulfur | 51.24 | 1.60 |
| Zinc | 18.6 | 0.28 |
| Totals | 98.75 | |

One of the uses for the data in Table 13 is the determination of the formula for Zn(DMcT)₂. Comparing the molar ratios of carbon to zinc: C=1.1, Zn=0.28 (moles carbon)/(moles zinc)=3.93 implies a formula of: Zn(C₂HN₂S₃)₂.

Apparently, under the conditions used for the precipitation, Zn²⁺ is replacing only the most acidic proton of DMcT.

### Summary and Conclusions

Mixed sprays of PANiDMcT and neutralized Zn(DMcT)₂ are promising CRA's based on ASTM B117 salt spray testing.

In the mixed spray applications, the polyDMcT coatings did not perform as well relative to the other inhibitors as they did when the layering method was used.

PANiDMcT looses effectiveness between 1000 and 2000 hours of salt spray exposure. As the PANiDMcT performance declines, there appears to be a simultaneous color change that could indicate exhaustion of the inhibitor supply through dedoping.

The best non-chromated primers applied over CCC 2024-T3 are comparable to the chromate controls. The primers that have been the most successful are ones that contain PANiDMcT or neutralized Zn(DMcT)₂

For a complete non-chromate system, neutralized Zn(DMcT)₂ has given the best results. This primer was applied over BAM-PPV instead of CCC and has passed 2000 hours of salt spray exposure.

The first filiform corrosion test provided passes for the four formulations tested, including the chromate primer control.

Dry tape adhesion was generally good.

Reverse impact tests (flexibility) gave passes for coatings that were not thicker than what was recommended by the military specifications.

Several analytical methods have been utilized for CRA characterization. The most useful ones appear to be IR, elemental analysis, and ion chromatography. IR indicates presence of different functional groups in some of the polyDMcT products. Elemental analysis gave a formula for the ZnDMcT pigment of Zn(C₂HN₂S₃)₂. Ion chromatography results suggest that PANiDMcT contains a significant amount of sulfate, so much that if the sulfate is present as the dopant for PANi, half of the PANi may be doped with sulfate.

### Example 11

This example illustrates the efficacy of the reduction of Cr(VI) to Cr(III) by the oxidation of DMcT.

In experiments described in Example 7, it was observed that DMcT caused a bleaching of chromate conversion coatings. The question arose as to whether this indicated a chemical change of the chromate conversion coating that could affect the conversion coating's ability to contribute to corrosion inhibition. Electrochemical experiments were performed to measure the effect of DMcT exposure on the chromate conversion coating's ability to release and inhibit the oxygen reduction reaction (ORR) at a rotating disk electrode (RDE).

A chromate conversion coated (CCC) Al 2024-T3 panel was placed in an aqueous solution containing DMcT and left to soak for 24 hours. After soaking, the panel was removed from the solution, washed off with deionized water, and used in a rotating disk electrode (RDE) experiment to determine the activity of the chromate conversion coating in a corrosion cell. Two other panels were also tested: a base Al 2024-T3 panel and a chromate conversion coated Al 2024-T3 panel that was not exposed to DMcT.

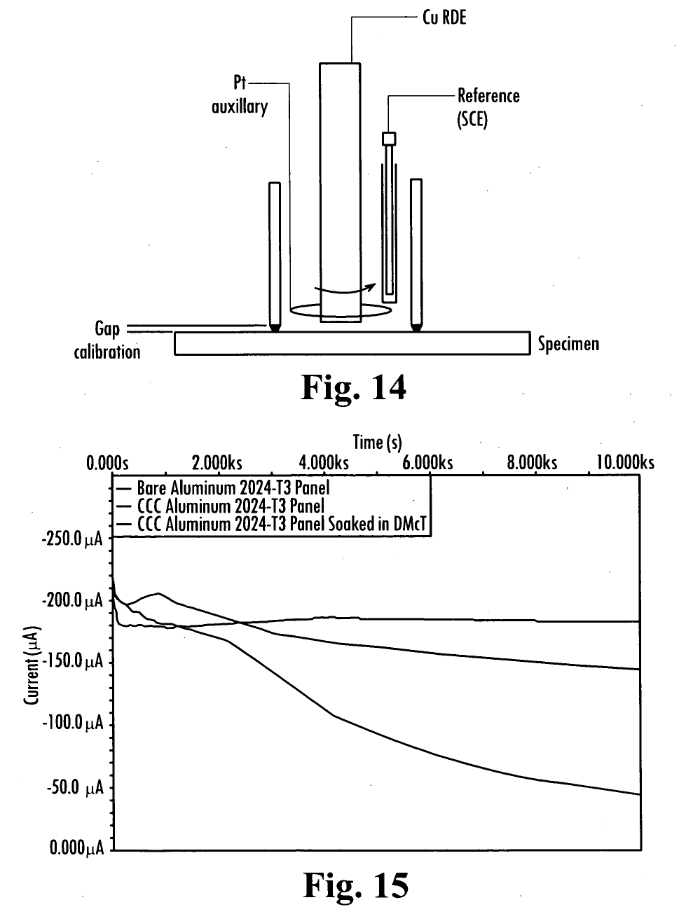

In this experiment a corrosion cell was assembled as shown in FIG. 14. Copper RDE (Pine Instrument Company, 5 mm i.d.) was coupled with the Pine Instrument Company rotator (model AFMSRX). The rotator was attached to the speed controller (Pine Instrument Company, model MSRX) used to control the rotation of the RDE at a constant 2000 rpm.

The distance between the tip of the RDE and the panel was measured to be 2.5 mm and was kept constant throughout the experiment. The cell was filled with 25.0 ml of 5% (wt/wt) NaCl solution in water.

A constant potential of −0.8 V was applied to the RDE by the Gamry PC14 potentiostat and the current was measured as a function of time. Each panel was tested for 10000 seconds.

Experimental results are illustrated in FIG. 15. The topmost curve at 10 ks represents the cathodic current observed for the bare aluminum panel and serves as control. The bottommost curve at 10 ks represents the cathodic current observed for the CCC panel. The significant decrease in cathodic current may be attributable to the dissolution of the Cr (VI) from the conversion coating and inhibiting the oxygen reduction reaction—the source of the cathodic current—that is occurring at the copper electrode, thus preventing corrosion. The middle curve at 10 ks represents the cathodic current observed for the CCC panel that was exposed to a solution of DMcT. The decrease in the current as compared to the red curve is less, suggesting that the amount of available Cr (VI) in the coating has been decreased by a reaction between the chromium and DMcT.

Knowledge of the ability of DMcT to reduce Cr(VI) to Cr(III) has led to the discovery that the corrosion resistant activity of a coating that contains Cr(VI) can be maintained for a longer period if the coating is isolated from contact with DMcT. Isolation of the DMcT-containing domain from the Cr(VI)-containing domain is believed to prevent or reduce reaction between the Cr(VI) and the DMcT. For example, it is best to separate a chromate conversion coating from a subsequent layer containing DMcT, or a compound such as polyDMcT or PANiDMcT that releases DMcT, in order to preserve the anti-corrosion effectiveness of both layers. The separation can be provided by a polymer that prevents or reduces the movement of DMcT across the layer. An epoxy layer can provide such separation.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments may be interchanged both in whole or in part.

What is claimed is:

1. A corrosion resisting coating for a surface of a metal that is subject to corrosion, the coating comprising:
a first domain comprising a binder polymer; and
a second domain which directly contacts the first domain and which comprises a corrosion-responsive agent that is selected from the group consisting of:
a) a mercapto-substituted organic and dimers, trimers, oligomers, or polymers thereof,
b) a thio-substituted organic and dimers, trimers, oligomers, or polymers thereof,
c) a dimer, trimer, oligomer, or polymer of an organic phosphonic acid or salt or ester thereof,
d) combinations of any of a), b), or c);
e) a salt of a mercapto-substituted organic and an intrinsically conductive polymer,
f) a salt of a thio-substituted organic and an intrinsically conductive polymer; and
h) combinations of any of a)-f).

2. The coating according to claim 1, wherein the first domain is substantially free of the corrosion responsive agent.

3. The coating according to claim 1, wherein the second domain contains the corrosion responsive agent in an amount that is above the critical pigment volume concentration.

4. The coating according to claim 1, further having a chrome conversion coat located between the metal surface and the corrosion resisting coating.

5. The coating according to claim 1, further having a layer of poly [bis(2,5-(N,N,N′,N′-tetralkyl)amine)-1,4-phenylene vinylene] (BAMPPV) located between the metal surface and the corrosion resisting coating.

6. The coating according to claim 1, wherein the first domain and the second domain are adjacent layers.

7. The coating according to claim 1, wherein the first domain and the second domain together form a single layer comprising multiple discrete but touching or overlapping regions of each of the first domain and the second domain.

8. The coating according to claim 4, wherein the first domain and the second domain are adjacent layers and wherein the first domain layer is in direct contact with the chrome conversion coat and isolates the chrome conversion coat from the second domain layer which covers the first domain layer.

9. The coating according to claim 8, wherein the coating further comprises at least one additional sequence of the first domain layer and the second domain layer and having a topmost layer of the first domain.

10. The coating according to claim 4, wherein the first domain and the second domain together form a single layer comprising multiple discrete but touching or overlapping regions of each of the first domain and the second domain and wherein the coating is separated and isolated from the chrome conversion coat by a barrier layer.

10. The coating according to claim 1, wherein the corrosion-responsive agent comprises poly(2,5-dimercapto-1,3,4-thiadiazole) (polyDMcT).

11. The coating according to claim 1, wherein the corrosion-responsive agent comprises the salt of polyaniline and 2,5-dimercapto-1,3,4-thiadiazole (PANiDMcT).

12. A method of protecting a surface of a metal from corrosion, the method comprising applying to the metal:
a formulation which cures to form a first domain comprising a binder polymer; and
a formulation that cures to form a second domain comprising a corrosion-responsive agent that is selected from the group consisting of:
a) a mercapto-substituted organic and dimers, trimers, oligomers, or polymers thereof,
b) a thio-substituted organic and dimers, trimers, oligomers, or polymers thereof,
c) a dimer, trimer, oligomer, or polymer of an organic phosphonic acid or salt or ester thereof,
d) combinations of any of a), b), or c);
e) a salt of a mercapto-substituted organic and an intrinsically conductive polymer,
f) a salt of a thio-substituted organic and an intrinsically conductive polymer; and
h) combinations of any of a)-f);
wherein the application of the liquid formulation which cures to form a first domain comprising a binder polymer and the application of the liquid formulation that cures to form a second domain is sequential or concurrent.

13. The method according to claim 12, wherein the metal is selected from iron, steel and aluminum.

14. The method according to claim 12, wherein the metal is a copper containing aluminum alloy.

15. The method according to claim 12, wherein the applying step comprises applying a chrome conversion coat directly to the metal surface before the application of the corrosion resisting coating.

16. The method according to claim 12, wherein the applying step comprises applying a layer of poly [bis(2,5-(N,N,N′,N′-tetralkyl)amine)-1,4-phenylene vinylene] (BAMPPV) directly to the metal surface before the application of the corrosion resisting coating.

17. The method according to claim 12, wherein the applying step comprises applying to the metal surface a liquid formulation that cures to form a first domain layer and then applying to the first domain layer a liquid formulation that cures to form a second domain layer.

18. The method according to claim 17, further comprising at least one sequence of applying to the second domain layer a liquid formulation that cures to form a first domain layer and then applying to the first domain layer a liquid formulation that cures to form a second domain layer and applying to the last second domain layer a liquid formulation that cures to form a topmost first domain layer.

19. The method according to claim 12, wherein the coating is applied by spraying onto the metal surface the liquid formulation which cures to form a first domain and the liquid formulation that cures to form a second domain from separate nozzles directed so that the spray patterns from the two nozzles overlap at the metal surface to form a single layer coating comprising multiple discrete but touching or overlapping regions of each of the first domain and the second domain.

20. The method according to claim 12, wherein the applying steps result in the formation of a coating having a thickness between about 0.015 mm and 0.025 mm.
